(19) United States
(12) Patent Application Publication
(10) Pub. No.: US 2026/0060326 A1
(43) Pub. Date: Mar. 5, 2026

(54) AEROSOL GENERATING DEVICE

(71) Applicant: KT&G CORPORATION, Daejeon (KR)

(72) Inventors: Won Kyeong LEE, Gyeonggi-do (KR); Sung Wook YOON, Gyeonggi-do (KR)

(73) Assignee: KT&G CORPORATION, Daejeon (KR)

(21) Appl. No.: 19/272,966

(22) Filed: Jul. 17, 2025

(30) Foreign Application Priority Data
Aug. 29, 2024 (KR) 10-2024-0116813

(51) Int. Cl. A24F 40/53; A24F 40/10; A24F 40/20; A24F 40/30; A24F 40/42; A24F 40/51; G01F 23/24

(52) U.S. Cl. CPC A24F 40/53; A24F 40/10; A24F 40/20; A24F 40/30; A24F 40/42; A24F 40/51; G01F 23/242

(57) ABSTRACT

An aerosol generating device includes a cartridge including a chamber in which a liquid aerosol generating material is stored, a sensor unit disposed on a side surface in the chamber and including a common electrode and one or more level electrodes, and a controller configured to calculate an amount of the liquid aerosol generating material in the chamber, based on whether there is electrical connection between the common electrode and the one or more level electrodes.

### CROSS-REFERENCE TO RELATED APPLICATION

This application is based on and claims priority under 35 U.S.C. § 119 to Korean Patent Application No. 10-2024-0116813, filed on Aug. 29, 2024, in the Korean Intellectual Property Office, the disclosure of which is incorporated by reference herein in its entirety.

### BACKGROUND

### 1. Field

The disclosure relates to an aerosol generating device, and more particularly, to an aerosol generating device including a liquid cartridge.

### 2. Description of the Related Art

An aerosol generating device is a device for extracting certain components from a medium or a material through an aerosol. The medium may include a multi-component material. The material included in the medium may be a multi-component flavoring material. For example, the material included in the medium may include a nicotine component, a herbal component, and/or a coffee component. Recently, various researches on aerosol generating devices have been conducted.

### SUMMARY

Provided is an aerosol generating device capable of precisely measuring the amount of a liquid accommodated in a cartridge.

However, objectives to be achieved by the embodiments are not limited thereto, and other unmentioned objectives will be apparent to one of ordinary skill in the art to which the embodiments pertain from the present specification and the attached drawings.

Additional aspects will be set forth in part in the description which follows and, in part, will be apparent from the description, or may be learned by practice of the presented embodiments.

According to an embodiment, an aerosol generating device includes a cartridge including a chamber in which a liquid aerosol generating material is stored, a sensor unit disposed on a side surface in the chamber and including a common electrode and one or more level electrodes, and a controller configured to calculate an amount of the liquid aerosol generating material in the chamber, based on whether there is electrical connection between the common electrode and the one or more level electrodes.

According to another embodiment, an aerosol generating device includes a cartridge including a chamber in which a liquid aerosol generating material is stored, a sensor unit disposed on an outer wall of the chamber and including one or more strain gauges configured to detect a change in resistance corresponding to deformation of the outer wall, and a controller configured to calculate an amount of the liquid aerosol generating material in the chamber, based on the changed resistance.

According to another embodiment, the outer wall of the chamber may comprise an elastic member on at least one side surface.

According to another embodiment, the one or more strain gauges may be arranged on the outer wall of the chamber along a longitudinal direction of the chamber to be spaced apart from each other by a certain interval.

According to another embodiment, the one or more strain gauges may comprise a first strain gauge, a second strain gauge, and a third strain gauge sequentially disposed from a bottom surface of the chamber toward a top surface of the chamber.

According to another embodiment, the controller may further configure to output a replacement alarm of the cartridge through an output unit, when the first strain gauge is less than a preset resistance value.

According to another embodiment, the aerosol generating device may further comprise a motion sensor; and an output unit.

According to another embodiment, the controller may further configure to determine an angle between the chamber and a direction perpendicular to a ground, based on a signal received from the motion sensor, output a warning through the output unit, based on the angle being greater than or equal to a preset threshold value, and activate the sensor unit to calculate an amount of the liquid aerosol generating material in the chamber, based on the angle being less than the preset threshold value.

According to another embodiment, the cartridge may comprise an atomizing unit configured to vaporize the liquid aerosol generating material.

### BRIEF DESCRIPTION OF THE DRAWINGS

The above and other aspects, features, and advantages of certain embodiments will be more apparent from the following description taken in conjunction with the accompanying drawings, in which:

FIG. 1 is a block diagram illustrating an aerosol generating device, according to an embodiment;

FIG. 2 illustrates an aerosol generating device, according to an embodiment;

FIG. 3 illustrates an aerosol generating device, according to another embodiment;

FIGS. 4 and 5 are views illustrating examples of a cigarette;

FIGS. 6A to 6C are schematic views for describing a cartridge, according to an embodiment;

FIG. 7 is a view for describing a positional relationship between a common electrode and a plurality of level electrodes and a method of detecting a liquid level, according to an embodiment;

FIG. 8A is a view illustrating an aspect of a sensor unit including a strain gauge, according to an embodiment;

FIG. 8B is a view illustrating another aspect of a sensor unit including a strain gauge, according to an embodiment;

FIG. 9 is a schematic view for describing a cartridge, according to an embodiment; and

FIG. 10 is a view for describing a positional relationship between a plurality of strain gauges and a method of detecting a liquid level, according to an embodiment.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. In the description of the drawings, similar or related components may be denoted by similar reference numerals.

In the following description, with respect to constituent elements used in the following description, the suffixes “module” and “unit” are used only in consideration of facilitation of description. The “module” and “unit” are do not have mutually distinguished meanings or functions. Meanwhile, the suffixes “module” or “unit” may include units implemented in hardware, software, or firmware, and may be used interchangeably with terms such as logic, logical blocks, components, or circuits. The “module” or “unit” may refer to an integrated component as a whole, or a minimum unit or a portion of the component that performs one or more functions. For example, the “module” or “unit” may be implemented in the form of an ASIC(Application-Specific Integrated Circuit).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments may be implemented as software including instructions stored in a storage medium (e.g., a memory 170) readable by a machine (e.g., an aerosol generating device 100). For example, a processor (e.g., a controller 120) of the machine (e.g., the aerosol generating device 100) may invoke and execute at least one of the one or more instructions stored in the storage medium. This allows the machine to operate to perform at least one function according to the at least one instruction invoked. The one or more instructions may include a code generated by a compiler or a code executable by an interpreter. The machine-readable storage medium may be provided as a non-transitory storage medium. Here, ‘non-transitory’ means that the storage medium does not include a signal (e.g., an electromagnetic wave) and is tangible, but does not distinguish whether data is stored semi-permanently or temporarily in the storage medium.

In the disclosure, a direction of the aerosol generating device 100 may be defined based on an orthogonal coordinate system. In the orthogonal coordinate system, an x-axis direction may be defined as a left-right direction of the aerosol generating device 100. A y-axis direction may be defined as a front-back direction of the aerosol generating device 100. A z-axis direction may be defined as an up-down direction of the aerosol generating device 100.

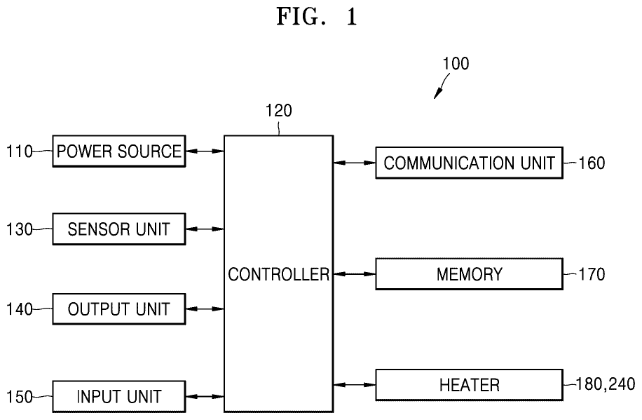

FIG. 1 is a block diagram illustrating the aerosol generating device 100, according to an embodiment.

According to an embodiment, the aerosol generating device 100 may include a power source 110, the controller 120, a sensor unit 130, an output unit 140, an input unit 150, a communication unit 160, the memory 170, and/or a heater 180 or 240. That is, it may be understood by one of ordinary skill in the art related to the present embodiment that some of elements illustrated in FIG. 1 may be omitted or new elements may be further added according to a design of the aerosol generating device 100.

According to an embodiment, the sensor unit 130 may detect a state of the aerosol generating device 100 or a state around the aerosol generating device 100, and may transmit detected information to the controller 120. For example, the sensor unit 130 may include a temperature sensor, a puff sensor, an insertion detection sensor, a reuse detection sensor, an overlay moist state detection sensor, a cigarette identification sensor, a cartridge detection sensor, a cap detection sensor, and/or a motion detection sensor. The sensor unit 130 may further include various sensors such as a liquid remaining amount sensor for detecting a liquid remaining amount of a cartridge, and an immersion sensor for detecting immersion of the aerosol generating device 100.

According to an embodiment, the temperature sensor may detect a temperature at which the heater 180 or 240 is heated. The aerosol generating device 100 may include a separate temperature sensor for detecting a temperature of the heater 180 or 240, or the heater 180 or 24 itself may function as a temperature sensor. For example, the temperature sensor may be used to measure impedance for the heater 180. The impedance for the heater 180 may be correlated with a temperature of the heater 180. The temperature sensor may measure current and/or a voltage applied to the heater 180 (or an induction coil). The impedance for the heater 180 may be calculated based on the measured current and/or voltage. The controller 120 may estimate a temperature of the heater 180 based on the calculated impedance.

For example, the temperature sensor may include a resistive device (e.g., a thermistor) whose resistance value changes in response to a change in a temperature of the heater 180 or 240. The temperature sensor may output a signal corresponding to a resistance value of the resistive device, and the controller 120 may detect a temperature and/or a change in a temperature of the heater 180 or 240 based on the signal corresponding to the resistance value.

In another example, the temperature sensor may include a sensor for detecting a resistance value of the heater 180 or 240. The temperature sensor may output a signal corresponding to the resistance value of the heater 180 or 240, and the controller 120 may detect a temperature and/or a change in a temperature of the heater 180 or 240 based on the signal corresponding to the resistance value.

According to an embodiment, the temperature sensor may detect a temperature of the power source 110. The temperature sensor may be disposed adjacent to the power source 110. For example, the temperature sensor may be attached to one surface of the power source 110 (e.g., a battery) and/or may be mounted on one surface of a printed circuit board. For example, the aerosol generating device 100 may include a power protection circuit module (PCM), and the temperature sensor may be disposed adjacent to the power source 110 together with the power PCM.

According to an embodiment, the temperature sensor may be disposed inside a housing (not shown) of the aerosol generating device 100 to detect a temperature inside the housing (not shown).

According to an embodiment, the puff sensor may detect a user's puff.

For example, the puff sensor may include a pressure sensor. The pressure sensor may output a signal corresponding to internal pressure of the aerosol generating device 100, and the controller 120 may detect the user's puff based on the signal corresponding to the internal pressure. The internal pressure of the aerosol generating device 100 may correspond to pressure of an airflow path through which gas flows. The puff sensor may be disposed to correspond to the airflow path through which gas flows in the aerosol generating device 100.

In another example, the puff sensor may include a temperature sensor. When the user's puff occurs, a temperature drop may temporarily occur in the airflow path, a space where an aerosol generating article is inserted (hereinafter, referred to as an insertion space), and the heater 180 or 240. The controller 120 may detect the user's puff based on a signal corresponding to a temperature of the airflow path or the like output from the temperature sensor.

In another example, the puff sensor may include both the pressure sensor and the temperature sensor. In this case, the temperature sensor may measure a temperature used to correct internal pressure measured by the pressure sensor. For example, the puff sensor may correct a signal corresponding to the internal pressure based on a temperature measured by the temperature sensor, and may output a corrected signal. In another example, the puff sensor may output a signal corresponding to a temperature measured by the temperature sensor and a signal corresponding to internal pressure measured by the puff sensor. In this case, the controller 120 may receive the signals and may correct the signal corresponding to the internal pressure based on the signal corresponding to the temperature.

In another example, the puff sensor may include a capacitance sensor. In the disclosure, the capacitance sensor may be referred to as a cap sensor or a capacitive sensor. When the user's puff occurs, a temperature change and/or an aerosol flow may occur in the insertion space of the aerosol generating article, and thus, a permittivity in the insertion space may change. The controller 120 may detect the user's puff based on a signal corresponding to a permittivity inside the insertion space output from the capacitance sensor.

The puff sensor is not limited to the above examples, and may be implemented as any of various sensors for detecting the user's puff.

According to an embodiment, the insertion detection sensor may detect insertion and/or removal of the aerosol generating article. The insertion detection sensor may be provided around the insertion space. Also, the insertion detection sensor may include any combination of the above examples.

For example, the insertion detection sensor may include a capacitance sensor. The capacitance sensor may include at least one conductor, and the at least one conductor may be disposed adjacent to the insertion space. When the aerosol generating article is inserted into or removed from the insertion space, a permittivity around the conductor may change. The controller 120 may detect insertion and/or removal of the aerosol generating article based on a signal corresponding to a permittivity inside the insertion space output from the capacitance sensor.

In another example, the insertion detection sensor may include an inductive sensor. The inductive sensor may include at least one coil, and the at least one coil may be disposed adjacent to the insertion space. When the aerosol generating article (e.g., a wrapper of the aerosol generating article) includes a conductor and the aerosol generating article is inserted into the insertion space or removed from the insertion space, a change in a magnetic field may occur around the coil through which current flows. The controller 120 may detect insertion and/or removal of the aerosol generating article including the conductor based on characteristics (e.g., a frequency of alternating current, a current value, a voltage value, an inductance value, and an impedance value) of current output from the inductive sensor or detected by the inductive sensor. Alternatively, a susceptor (SUS) may be included in the aerosol generating article (e.g., a medium portion of the aerosol generating article). Even in this case, a change in a magnetic field may occur around the coil based on insertion or removal of the susceptor into or from the insertion space, and the controller 120 may detect insertion and/or removal of the aerosol generating article based on characteristics of current of the inductive sensor.

The insertion detection sensor is not limited to the above examples, and may be implemented as any of various sensors (e.g., a proximity sensor) for detecting insertion and/or removal of the aerosol generating article. Also, the insertion detection sensor may include any combination of the above examples. According to an embodiment, the insertion detection sensor may include a switch for detecting pressing by the aerosol generating article.

According to an embodiment, the reuse detection sensor may detect whether the aerosol generating article is reused. For example, the reuse detection sensor may be a color sensor for detector a color of the aerosol generating article. When the aerosol generating article is used by the user, a color of a part of a wrapper surrounding the outside of the aerosol generating article may change due to a generated aerosol or heating. The color sensor may output a signal corresponding to an optical characteristic (e.g., a wavelength of light) corresponding to the color of the wrapper based on light reflected from the wrapper. When a change in a color of a part of the wrapper is detected, the controller 120 may determine that the aerosol generating article inserted into the insertion device has already been used.

According to an embodiment, the overly moist state detection sensor may detect whether the aerosol generating article is in an overly moist state. For example, the overly moist state detection sensor may include a capacitance sensor. The capacitance sensor may include at least one conductor disposed adjacent to the insertion space. The controller 120 may detect whether the aerosol generating article is in an overly moist state, based on a level of a signal corresponding to a permittivity output from the capacitance sensor. For example, the controller 120 may check a level range including the level of the signal based on a lookup table, and may determine a moisture content for the aerosol generating article based on the checked level range.

According to an embodiment, the cigarette identification sensor may detect whether the aerosol generating article is genuine and/or may detect a type of the aerosol generating article.

For example, the cigarette identification sensor may include an optical sensor for detecting an identification material (e.g., an identification mark) located on an outer surface (e.g., the wrapper) of the aerosol generating article. The optical sensor may irradiate light toward the identification material (or the identification mark) of the aerosol generating article, and may detect whether the aerosol generating article is genuine and/or a type of the aerosol generating article based on reflected light. For example, the identification material may include a material that emits light of a specific wavelength band based on the irradiated light. The controller 120 may detect whether the aerosol generating article is genuine and/or a type of the aerosol generating article, based on the wavelength range.

In another example, the cigarette identification sensor may include a capacitance sensor. A permittivity inside the insertion space may be different according to a type of the aerosol generating article inserted into the insertion space. The controller 120 may detect whether the aerosol generating article is genuine and/or a type of the aerosol generating article based on a signal corresponding to a permittivity inside the insertion space output from the capacitance sensor.

In another example, the cigarette identification sensor may include an inductive sensor. When a conductor is included in the wrapper and/or the inside (e.g., the medium portion) of the aerosol generating article, characteristics of current (e.g., a frequency of alternating current, a current value, a voltage value, an inductance value, and an impedance value) of current detected by the inductive sensor when the aerosol generating article is inserted into the insertion space may be different according to a type of the aerosol generating article inserted into the insertion space. The controller 120 may detect whether the inserted aerosol generating article is genuine and/or a type of the inserted aerosol generating article, based on characteristics of current output from the inductive sensor or detected by the inductive sensor.

The cigarette identification sensor is not limited to the above examples, and may be implemented as any of various sensors for detecting whether the aerosol generating article is genuine and/or a type of the aerosol generating article. Also, the cigarette identification sensor may include any combination of the above examples.

According to an embodiment, the cartridge detection sensor may detect mounting and/or removal of the cartridge. For example, the cartridge detection sensor may include an inductive sensor, a capacitance sensor, a resistance sensor, a hall sensor (IC), and/or an optical sensor.

According to an embodiment, the cap detection sensor may detect mounting and/or removal of a cap. For example, the cap detection sensor may include an inductive sensor, a capacitance sensor, a resistance sensor, a contact sensor, a hall sensor (IC), and/or an optical sensor. The cap may include a structure that covers at least a part of the cartridge mounted or inserted into the aerosol generating device 100 or covers at least a part of the housing of the aerosol generating device 100. When the cap is mounted in the housing or removed from the housing, the cap detection sensor may output a signal corresponding to the mounting or removal, and the controller 120 may detect mounting or removal of the cap based on the signal corresponding to the mounting or removal.

According to an embodiment, the motion detection sensor may detect a motion of the aerosol generating device 100. The motion detection sensor may be implemented as at least one of an acceleration sensor or a gyro sensor.

According to an embodiment, the sensor unit 130 may further include at least one of a humidity sensor, atmospheric pressure sensor, a magnetic sensor, a position sensor (e.g., global positioning system (GPS)), or a proximity sensor, in addition to the above sensors. Functions of the respective sensors may be intuitively inferred from names thereof by one of ordinary skill in the art, and thus, detailed descriptions thereof may be omitted.

According to an embodiment, the output unit 140 may output information about a state of the aerosol generating device 100. The output unit 140 may include, but is not limited to, a display, a haptic unit, and/or a sound output unit. For example, the information about the aerosol generating device 100 may include a charging/discharging state of the power source 110 of the aerosol generating device 100, a preheating state of the heater 180 or 240, an insertion/removal state of the aerosol generating article and/or the cartridge, a mounting and/or removal state of the cap, or a limited usage state of the aerosol generating device 100 (e.g., abnormal article detection). The display may visually provide, to the user, the information about the state of the aerosol generating device 100. For example, the display may include a light-emitting diode (LED) light-emitting device, a liquid crystal display (LCD) panel, or an organic light-emitting diode (OLED) panel. When the display includes a touch pad, the display may also be used as the input unit 150. The haptic unit may provide, to the user, the information about the state of the aerosol generating device 100 in a haptic way. For example, the haptic unit may include a vibration motor, a piezoelectric element, or an electrical stimulation device. The sound output unit may audibly provide, to the user, the information about the aerosol generating device 100 in an auditory way. For example, the sound output unit may convert an electrical signal into a sound signal and may output the sound signal to the outside.

According to an embodiment, the power source 110 may supply power for an operation of the aerosol generating device 100. The power source 110 may include one or more batteries. The power source 110 may supply power to heat the heater 180 or 240. Also, the power source 110 may supply power necessary for operations of the controller 120, the sensor unit 130, the output unit 140, the input unit 150, the communication unit 160, and the memory 170, which are other elements included in the aerosol generating device 100. The power source 110 may be a rechargeable battery or a disposable battery. For example, the power source 110 may be, but is not limited to, a lithium polymer (LiPoly) battery. The power source 110 may be a replaceable type (separable) battery (hereinafter, referred to as a detachable battery). The detachable battery may be mounted in a battery receiving portion provided in the aerosol generating device 100 or may be removed from the battery receiving portion. The detachable battery may be charged by wire and/or wirelessly.

According to an embodiment, the heater 180 or 240 may receive power from the power source 110 to heat a medium and/or an aerosol generating material in the aerosol generating article and/or the cartridge. The aerosol generating device 100 may include the heater 180 for heating the aerosol generating article and/or the cartridge heater 240 for heating the cartridge (e.g., a solid and/or liquid medium).

According to an embodiment, the heater 180 or 240 may be an electrically resistive heater. For example, the electrically resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome. The electrically resistive heater may be implemented as a metal wire, a metal heating plate on which an electrically conductive track is disposed, or a ceramic heating element.

According to an embodiment, the heater 180 or 240 may be an induction heater. For example, the induction heater may include a susceptor that generates heat due to a magnetic field. A magnetic field may be generated from an induction coil, due to alternating current flowing through the induction coil. The generated magnetic field may pass through the heater, and eddy current may be generated in the susceptor. The susceptor may be heated based on the generation of the eddy current. According to an embodiment, the susceptor may also be included inside the aerosol generating article (e.g., the medium portion). Even in this case, the susceptor included inside the aerosol generating article may be heated by the induction coil.

The heater 180 or 240 is not limited to the above examples, and may include or may be replaced with various heating methods, structures, and elements for heating the aerosol generating article and/or the cartridge.

According to an embodiment, the input unit 150 may receive information input from the user. For example, the input unit 150 may include a touch panel, a button, a keypad, a dome switch, a jog wheel, or a jog switch.

According to an embodiment, the memory 170 is hardware in which various pieces of data processed in the aerosol generating device 100 are stored, and the memory 170 may store pieces of data processed and to be processed by the controller 120. For example, the memory 170 may include at least one type of storage medium from among a flash memory type, a hard disk type, a multimedia card micro type, a card type memory (e.g., an SD or XD memory), random-access memory (RAM), static random-access memory (SRAM), read-only memory (ROM), electrically erasable programmable read-only memory (EEPROM), programmable read-only memory (PROM), a magnetic memory, a magnetic disk, and an optical disk. For example, the memory 170 may store data on an operation time of the aerosol generating device 100, a maximum number of puffs, a current number of puffs, at least one temperature profile, and the user's smoking pattern.

According to an embodiment, the communication unit 160 may include at least one element for communication with another electronic device (e.g., a portable electronic device). For example, the communication unit 160 may include a Bluetooth communication unit, a Bluetooth low energy (BLE) communication unit, a near field communication unit, a wireless local area network (WLAN) communication unit, a Zigbee communication unit, an infrared data association (IrDA) communication unit, a wireless fidelity direct (WFD) communication unit, an ultra wideband (UWB) communication unit, an adaptive network topology (Ant)+ communication unit, a cellular network communication unit, an Internet communication unit, or a computer network (e.g., LAN or WAN) communication unit.

According to an embodiment, the controller 120 may control an overall operation of the aerosol generating device 100. For example, the controller 120 may include at least one processor. The controller 120 may be implemented as an array of a plurality of logic gates, or may be implemented as a combination of a general-purpose microcontroller unit (MCU) or a microprocessor and a memory storing a program that may be executed in the MCU. Also, it may be understood by one of ordinary skill in the art to which the present embodiment pertains that the controller 120 may be implemented as another type of hardware.

According to an embodiment, the controller 120 may control a temperature of the heater 180 or 240 by controlling power supply from the power source 110 to the heater 180 or 240. The controller 120 may control a temperature of the heater 180 or 240 and/or power supplied to the heater 180 or 240, based on a temperature of the heater 180 or 240 detected by using the temperature sensor (e.g., the sensor unit 130). The controller 120 may control a temperature of the heater 180 or 240 and/or power supplied to the heater 180 or 240, based on a temperature profile and/or a power profile stored in the memory 170.

According to an embodiment, the controller 120 may control power (e.g., a voltage and/or current) supplied to the heater 180 or 240, by controlling a power conversion circuit (not shown) electrically connected to the heater 180 or 240 and the power source 110. For example, the power conversion circuit may include a DC/DC converter (e.g., a buck-converter, a buck-boost converter, a boost converter, or a Zener diode) for converting power to be supplied to the heater 180 or 240, and a DC/AC converter (e.g., an inverter) for converting power to be supplied to an induction coil (not shown). The DC/AC converter may be implemented as a full-bridge circuit or a half-bridge circuit including a plurality of switching devices. For example, the power conversion circuit may include at least one switching device such as a bipolar junction transistor (BJT) or a field effect transistor.

According to an embodiment, the controller 120 may adjust current and/or a voltage supplied to the heater 180 or 240, by adjusting a frequency or a duty ratio of a current pulse input to at least one switching device of the power conversion circuit (not shown). A duty ratio for an on/off operation of the switching device may correspond to a ratio of a voltage output from the power conversion circuit to a voltage output from the power source 110.

According to an embodiment, the controller 120 may control power supplied to the heater 180 or 240, by using at least one of a pulse width modulation (PWM) method and a proportional-integral-differential (PID) method. For example, the controller 120 may control a current pulse having a certain frequency and duty ratio to be supplied to the heater 180 or 240, by using the PWM method. The controller 120 may control power supplied to the heater 180 or 240 by adjusting the frequency and the duty ratio of the current pulse. For example, the controller 120 may determine a target temperature to be controlled, based on the temperature profile. The controller 120 may control power supplied to the heater 180 or 240, by using the PID method, which is a feedback control method through a difference value between the temperature of the heater 180 or 240 and the target temperature, a value obtained by integrating the difference value over time, and a value obtained by differentiating the difference value over time.

According to an embodiment, the controller 120 may determine target power to be controlled, based on the power profile. The controller 120 may control power supplied to the heater 180 or 240 to correspond to the preset target power over time.

According to an embodiment, the controller 120 may detect the user's puff by detecting power supplied to the heater 180 or 240. In more detail, the controller 120 may control power supplied to the heater 180 or 240 by using the PID method. When the user's puff occurs, a temperature drop may temporarily occur in a space (hereinafter, an insertion space) into which the aerosol generating article is inserted, and the heater 180 or 240. Accordingly, a change may occur power (or current) supplied to the heater 180 or 240 during power control using the PID method. The controller 120 may detect the user's puff based on the change in the controlled power.

According to an embodiment, the controller 120 may prevent the heater 180 or 240 from overheating. For example, the controller 120 may control an operation of the power conversion circuit to reduce the amount of power supplied to the heater 180 or 240 or to stop power supply to the heater 180 or 240, based on a temperature of the heater 180 or 240 exceeding a preset limit temperature.

According to an embodiment, the controller 120 may control charging/discharging of the power source 110. For example, the controller 120 may check a temperature of the power source 110 by using the temperature sensor (e.g., the sensor unit 130). When a temperature of the power source 110 is higher than or equal to a first limit temperature, the controller 120 may turn off charging of the power source 110. When a temperature of the power source 110 is higher than or equal to a second limit temperature, the controller 120 may stop using power (e.g., discharging) stored in the power source 110. The controller 120 may calculate a remaining capacity for power stored in the power source 110. For example, the controller 120 may calculate a remaining capacity of the power source 110 based on a voltage and/or current sensing value of the power source 110.

According to an embodiment, the controller 120 may control power supply to the heater 180 or 240, based on a detection result by the sensor unit 130.

According to an embodiment, the controller 120 may control power supply to the heater 180 or 240 based on insertion and/or removal of the aerosol generating article into or from the insertion space. For example, when it is determined that the aerosol generating article is inserted into the insertion space by using the insertion detection sensor (e.g., the sensor unit 130), the controller 120 may control power to be supplied to the heater 180 or 240. When it is determined that the aerosol generating article is removed from the insertion space by using the insertion detection sensor (e.g., the sensor unit 130), the controller 120 may cut off power supply to the heater 180 or 240. When a temperature of the heater 180 or 240 is higher than or equal to a limit temperature or a temperature change gradient of the heater 180 or 240 is greater than or equal to a set gradient, the controller 120 may determine that the aerosol generating article is removed from the insertion space.

According to an embodiment, the controller 120 may control a power supply time and/or a power supply amount to the heater 180 or 240 based on a state of the aerosol generating article. For example, when it is determined that the aerosol generating article is in an overly moist state by using the overly moist state detection sensor (e.g., the sensor unit 130), the controller 120 may increase the power supply time (e.g., preheating time) to the heater 180 or 240.

According to an embodiment, the controller 120 may control power supply to the heater 180 or 240 based on whether the aerosol generating article is reused. For example, when it is determined that the aerosol generating article is reused, the controller 120 may cut off power supply to the heater 180 or 240.

According to an embodiment, the controller 120 may control power supply to the heater 180 or 240 based on whether the cartridge is coupled and/or removed. For example, when it is determined that the cartridge is separated by using the cartridge detection sensor (e.g., the sensor unit 130), the controller 120 may stop power supply to the heater 180 or 240 or may control power not to be supplied to the heater 180 or 240.

According to an embodiment, the controller 120 may control power supply to the heater 180 or 240 based on whether the aerosol generating material of the cartridge is exhausted. For example, when it is determined that a temperature of the heater 180 or 240 exceeds a limit temperature while preheating the heater 180 or 240 (i.e., in a preheating period), the controller 120 may determine that the aerosol generating material of the cartridge is exhausted. When it is determined that the aerosol generating material of the cartridge is exhausted, the controller 120 may cut off power supply to the heater 180 or 240.

According to an embodiment, the controller 120 may control power supply to the heater 180 or 240 based on whether the cartridge is usable. For example, when it is determined that a current number of puffs is greater than or equal to a maximum number of puffs set to the cartridge based on data stored in the memory 170, the controller 120 may determine that the cartridge may not be usable. Alternatively, when a total time for which the heater 180 or 240 is heated is greater than or equal to or a preset maximum time or a total amount of power supplied to the heater 180 or 240 is greater than or equal to a preset maximum amount of power, the controller 120 may determine that the cartridge may not be usable. In this case, the controller 120 may stop power supply to the heater 180 or 240 or may control power not to be supplied to the heater 180 or 240.

According to an embodiment, the controller 120 may control power supply to the heater 180 or 240 based on the user's puff. For example, the controller 120 may determine whether a puff occurs and/or an intensity of the puff, by using the puff sensor (e.g., the sensor unit 130). When the number of puffs reaches a preset maximum number of puffs and/or when a puff is not detected for a preset time or more, the controller 120 may cut off power supply to the heater 180 or 240. When a puff is detected, the controller 120 may control power supply to the heater 180 or 240.

According to an embodiment, the controller 120 may control power supply to the heater 180 or 240 based on whether the aerosol generating article (or the cartridge) is genuine and/or a type of the aerosol generating article (or the cartridge). For example, the controller 120 may detect whether the aerosol generating article is genuine and/or a type of the aerosol generating article, by using the cigarette identification sensor (e.g., the sensor unit 130). For example, when it is determined that the aerosol generating article (or the cartridge) is not genuine, the controller 120 may cut off power supply to the heater 180 or 240. When it is determined that the aerosol generating article (or the cartridge) is genuine, the controller 120 may control (e.g., start) power supply to the heater 180 or 240. In another example, the controller 120 may differently control power supply to the heater 180 or 240 according to a type of the aerosol generating article (or the cartridge). In more detail, the controller 120 may control a temperature and/or power of the heater 180 or 240 based on a first temperature profile (or a first power profile) when it is detected that the aerosol generating article (or the cartridge) is a first aerosol generating article (or a first cartridge), and may control a temperature and/or power of the heater 180 or 240 based on a second temperature profile (or a second power profile) when it is detected that the aerosol generating article (or the cartridge) is a second aerosol generating article (or a second cartridge).

According to an embodiment, the controller 120 may control the output unit 140 based on a detection result by the sensor unit 130. For example, when the number of puffs counted by using the puff sensor (e.g., the sensor unit 130) reaches a preset number, the controller 120 may control the output unit 140 to visually, tactilely, and/or audibly provide information indicating that the aerosol generating device 100 is about to be terminated. For example, the controller 120 may control the output unit 140 to visually, tactilely, and/or audibly provide information about a temperature of the heater 180 or 240.

According to an embodiment, the controller 120 may store and update, in the memory 170, a history of a certain event that occurs based on the occurrence of the event. For example, the event may include detection of insertion of the aerosol generating article performed in the aerosol generating device 100, initiation of heating of the aerosol generating article, detection of a puff, termination of the puff, detection of overheating of the heater 180 or 240, detection of application of an overvoltage to the heater 180 or 240, termination of heating of the aerosol generating article, an operation such as power on/off of the aerosol generating device 100, detection of overcharging of the power source 110, and termination of charging of the power source 110. For example, the history of the events may include a date and time when the event occurs and log data corresponding to the event. For example, when the certain event is the detection of insertion of the aerosol generating article, the log data corresponding to the event may include data about a sensing value of the insertion detection sensor (e.g., the sensor unit 130). For example, when the certain event is the detection of overheating of the heater 180 or 240, the log data corresponding to the event may include data about a temperature of the heater 180 or 240, a voltage applied to the heater 180 or 240, and current flowing through the heater 180 or 240.

According to an embodiment, the controller 120 may control the communication unit 160 to form a communication link with an external device such as a mobile terminal of the user.

According to an embodiment, when data about authentication is received from the external device through the communication link, the controller 120 may release a restriction on the use of at least one function (e.g., heating function) of the aerosol generating device 100. For example, the data about authentication may include the user's birthday, a unique number indicating the user, and whether the user's authentication is completed.

According to an embodiment, the controller 120 may transmit data about a state of the aerosol generating device 100 (e.g., a remaining capacity and an operation mode of the power source 110) to the external device through the communication link. The transmitted data may be output through a display or the like of the external device.

According to an embodiment, when a location search request of the aerosol generating device 100 is received from the external device through the communication link, the controller 120 control the output unit 140 to perform an operation corresponding to the location search. For example, the controller 120 may control the haptic unit to generate vibration, or may control the display to output an object corresponding to location search and search termination.

According to an embodiment, the controller 120 may perform a firmware update, when firmware data is received from the external device through the communication link.

According to an embodiment, the controller 120 may transmit data about a sensing value of the at least one sensor unit 130 to an external server (not shown) through the communication link, and may receive and store, from the server, a learning model generated by learning the sensing value through machine learning such as deep learning. The controller 120 may perform an operation of determining the user's inhalation pattern and an operation of generating a temperature profile, by using the learning model received from the server.

Although not shown in FIG. 1, the aerosol generating device 100 may further include a power protection circuit. The power protection circuit includes at least one switching device, and may cut off an electrical path for the power source 110 in response to overcharging and/or overdischarging of the power source 110. The aerosol generating device 100 may further include a connection interface such as a universal serial bus (USB) interface, and may transmit and receive information to and from another external device or may charge the power source 110 through the connection interface.

The aerosol generating article in the disclosure may include at least one aerosol generating rod (e.g., medium portion) and at least one filter rod. The heater 180 may be disposed to correspond to the at least one aerosol generating rod, and may be differently designed according to the arrangement order and/or positions of the aerosol generating rod and the filter rod. The aerosol generating rod may include at least one of nicotine, an aerosol generating material, and an additive. For example, the aerosol generating material may include glycerin (e.g., vegetable glycerin (VG)) and/or propylene glycol (PG), and may include various other materials. For example, the additive may include a flavoring agent and/or an organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco or reconstituted tobacco). The tobacco material may be included in the aerosol generating rod in any of various forms such as a cut filler, granules, or powder. According to an embodiment, the additive of the aerosol generating rod may include a basic material. Based on the basic material, the nicotine of the tobacco material included in the aerosol generating rod may have a basic pH (e.g., pH 7.0 or higher). In this case, freebase nicotine may be released from the aerosol generating rod even at a low temperature. According to an embodiment, the aerosol generating rod may include two or more aerosol generating rods, and the two or more aerosol generating rods may each include a tobacco material and/or a non-tobacco material. Although not shown, at least one aerosol generating rod and at least one filter rod may be individually and/or integrally wrapped by at least one wrapper. In the disclosure, the aerosol generating article may be referred to as a stick.

The cartridge in the disclosure may contain an aerosol generating material in any one of a liquid state, a solid state, a gaseous state, or a gel state therein. The aerosol generating material may include a liquid composition. For example, the liquid composition may be a liquid including a tobacco-containing material including a volatile tobacco flavoring component, or may be a liquid including a non-tobacco material. The cartridge may include a storage including an aerosol generating material and a liquid delivery means in which the aerosol generating material is impregnated (contained). For example, the liquid delivery means may include a wick such as cotton fiber, ceramic fiber, glass fiber, or porous ceramic. The cartridge heater 240 may be included in the cartridge in a coil-shaped structure that is wound around the liquid delivery means or in a structure that contacts one side of the liquid delivery means. Alternatively, the cartridge heater 240 may be included in the aerosol generating device 100 that is separable from the cartridge.

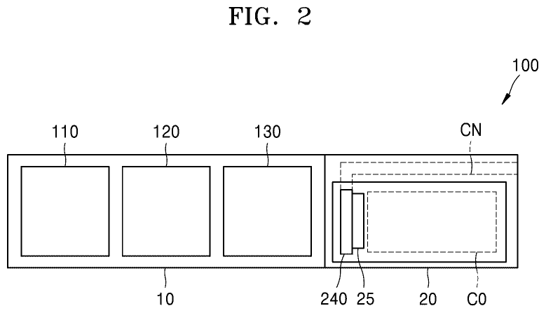

FIG. 2 illustrates the aerosol generating device 100, according to an embodiment.

According to an embodiment, the aerosol generating device 100 may include a housing 10, the power source 110, the controller 120, and/or the sensor unit 130. However, it may be understood by one of ordinary skill in the art related to the present embodiment that elements included in the aerosol generating device 100 are not limited to those illustrated in FIG. 2, and some of the elements may be omitted or new elements may be added. In the following drawings, the same description as that made with reference to FIG. 1 will be omitted.

According to an embodiment, the housing 10 may have a structure for inserting or mounting the cartridge 20 on one side. In this case, the cartridge 20 may be detachably coupled to the housing 10.

Although not shown, the housing 10 and/or the cartridge 20 may include a mouthpiece. The user may inhale an aerosol with the mouthpiece in his/her mouth.

According to an embodiment, the cartridge 20 may include a chamber C0 in which an aerosol generating material is contained. The chamber C0 may contain an aerosol generating material in any one of a liquid state, a solid state, a gaseous state, or a gel state. The aerosol generating material may include a liquid composition. For example, the liquid composition may be a liquid including a tobacco-containing material including a volatile tobacco flavoring component, or may be a liquid including a non-tobacco material.

According to an embodiment, a liquid delivery means 25 in which an aerosol generating material is impregnated (contained) may be included in the cartridge 20. For example, the liquid delivery means 25 may impregnate the aerosol generating material supplied from the chamber C0. The liquid delivery means 25 may include a wick such as cotton fiber, ceramic fiber, glass fiber, or porous ceramic. Although not shown, the aerosol generating device 100 may further include a liquid delivery means. In this case, at least a part of a first liquid delivery means of the cartridge 20 and at least a part of a second liquid delivery means of the aerosol generating device 100 may be formed to contact each other. In this case, the first liquid delivery means and the second liquid delivery means may be implemented in different forms. For example, the first liquid delivery means may include cotton fiber, and the second liquid delivery means may include porous ceramic. Alternatively, a liquid delivery means may not be included in the cartridge 20, and an aerosol generating material of the cartridge 20 may be transferred to a liquid delivery means of the aerosol generating device 100.

According to an embodiment, an airflow channel through which air flows may be provided in the housing 10 and/or the cartridge 20.

For example, the housing 10 may have a structure in which external air may be introduced into the housing 10 in a state where the cartridge 20 is coupled. For example, an air inlet through which external air may be introduced into the housing 10 may be formed on one side surface of the housing 10. The air inlet may be formed on a lower surface of the housing 10. External air introduced into the housing 10 through the air inlet may pass through the cartridge 20 and then may flow toward the user's oral cavity through an airflow channel CN. The external air introduced through the air inlet may pass through the cartridge 20 and may flow to the user's oral cavity through the airflow channel CN.

For example, the airflow channel CN may be included in the cartridge 20. The airflow channel CN may connect a chamber (e.g., an atomizing chamber) in which the cartridge heater 240 or the liquid delivery means 25 is disposed to the outside of the housing 10 and/or the cartridge 20. In more detail, one end of the airflow channel CN may be open to the chamber (e.g., the atomizing chamber) in which the cartridge heater 240 or the liquid delivery means 25 is disposed, and the other end of the airflow channel CN may communicate with the mouthpiece. The airflow channel CN may extend long along a longitudinal direction of the cartridge 20 on one side of the chamber C0 of the cartridge 20. Alternatively, the airflow channel CN may pass through the chamber C0 of the cartridge 20 and may extend long along the longitudinal direction of the cartridge 20. The airflow channel CN may communicate with a mouthpiece separately provided in the housing 10.

According to an embodiment, the cartridge heater 240 may heat an aerosol generating material included in the cartridge 20. For example, the cartridge heater 240 may include an electro-resistive heater and/or an induction heater. For example, the electro-resistive heater may include an electro-resistive material, and may be heated as current flows through the electro-resistive material. In another example, when the cartridge heater 240 is an induction heater, the aerosol generating device 100 may further include an induction coil (not shown) around the induction heater. The induction heater may include a susceptor, and may generate heat based on a magnetic field generated from the induction coil (not shown). The cartridge heater 240 may be formed in a coil shape that is wound around a liquid delivery means included in the cartridge 20 and/or the aerosol generating device 100 and/or in a shape (e.g., a pattern shape) that contacts one side of the liquid delivery means.

According to an embodiment, the cartridge heater 240 may be included in the cartridge 20. When the cartridge 20 is detachable from the housing 10, the cartridge heater 240 may be detachable from the aerosol generating device 100 together with the cartridge 20. Unlike what is shown, the cartridge heater 240 may be included in the aerosol generating device 100. For example, the cartridge heater 240 may be included in the housing 10. The cartridge heater 240 may be included in a detachable form from the housing 10 separately (i.e., independently) from the cartridge 20. In other words, the cartridge heater 240 may or may not be separated from the housing 10, regardless of whether the cartridge 20 is separated.

According to an embodiment, an aerosol may be generated based on heat generation of the cartridge heater 240. As the liquid delivery means 25 is heated by the cartridge heater 240, an aerosol may be generated. For example, as an aerosol generating material impregnated in the liquid delivery means 25 is heated by the cartridge heater 240, vapor may be generated from the aerosol generating material, and as the generated vapor is mixed with external air introduced into the cartridge 20, an aerosol may be generated. The aerosol generated by the cartridge heater 240 may be inhaled into the user's oral cavity through the airflow channel CN.

According to an embodiment, the cartridge 20 may be integrally formed with the aerosol generating device 100 (e.g., the housing 10). The cartridge 20 may be formed so that the cartridge 20 may not be separated from the aerosol generating device 100 by the user. Even in this case, the cartridge 20 and/or the aerosol generating device 100 may include at least one liquid delivery means, an aerosol may be generated based on the cartridge heater 240 included in the aerosol generating device 100 or the cartridge 20 heating the liquid delivery means 25, and the generated aerosol may be inhaled into the user's oral cavity through the airflow channel CN.

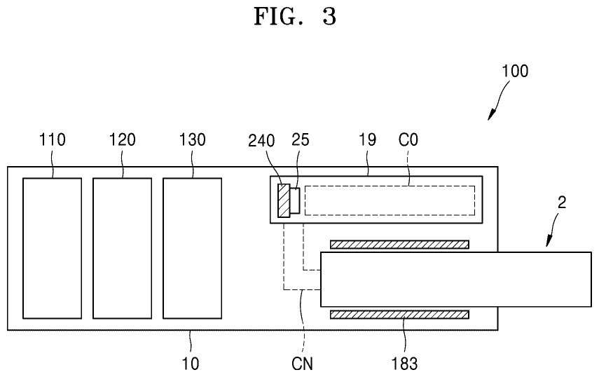

FIG. 3 illustrates the aerosol generating device 100, according to another embodiment.

According to an embodiment, the aerosol generating device 100 may include the housing 10, the power source 110, the controller 120, the sensor unit 130, and/or an heater 183 or 240 (e.g., the heater 180 or 240 of FIG. 1). However, it may be understood by one of ordinary skill in the art related to the present embodiment that elements included in the aerosol generating device 100 are not limited to those illustrated in FIG. 3, and some of the elements may be omitted or new elements may be added. In the following drawings, the same description as that made with reference to FIG. 1 will be omitted.

According to an embodiment, the housing 10 may provide a space (hereinafter, referred to as an insertion space) that is open upward and through which a cigarette 2 is inserted. The insertion space may be recessed by a certain depth toward the inside of the housing 10 so that at least a part of the cigarette 2 is inserted. A lower end of the cigarette 2 may be inserted into the housing 10, and an upper end of the cigarette 2 may protrude outward from the housing 10.

Unlike what is shown, a cartridge 19 may provide an insertion space in which the cigarette 2 is to be accommodated. In this case, the insertion space may be recessed by a certain depth toward the inside of the cartridge 19 so that at least a part of the cigarette 2 is inserted. A lower end of the cigarette 2 may be inserted into the cartridge 19, and an upper end of the cigarette 2 may protrude outward from the cartridge 19. Also, in this case, the aerosol generating device 100 may not include the heater 183.

According to an embodiment, a depth of the insertion space may be greater than or equal to a length of an area including an aerosol generating material and/or a medium. The user may inhale air with the upper end of the cigarette 2 exposed to the outside in his/her mouth.

According to an embodiment, the heater 183 may heat the cigarette 2. The heater 183 may extend long upward around the space (i.e., the insertion space) into which the cigarette 2 is inserted. For example, the heater 183 may have a tube shape (e.g., a cylindrical shape) having a hollow portion therein. The heater 183 may have a hollow portion therein and may have a shape surrounding the hollow portion. In this case, the heater 183 may be supported by a polyimide film. A heater supported by such a film may be referred to as a film heater. The heater 183 may be disposed to surround at least a part of the insertion space. The heater 183 may heat an outer side of the cigarette 2 inserted into the hollow portion. In the disclosure, the heater 183 may be referred to as an external heating-type heater that heats the outer side of the cigarette 2. A heat insulating material may be disposed outside the heater 183. Accordingly, heat radiated outward from the heater 183 and applied to the outside of the housing 10 may be reduced.

According to an embodiment, the heater 183 may include an electro-resistive heater and/or an induction heater.

For example, the electro-resistive heater may include an electro-resistive material, and may be heated as current flows through the electro-resistive material. In this case, the electro-resistive heater may be electrically connected to the power source 110, and may directly generate heat by receiving current from the power source 110.

For example, when the heater 183 is an induction heater, the aerosol generating device 100 may further include an induction coil (not shown) surrounding at least a part of the heater 183 (e.g., disposed outside to correspond to a length of at least a part of the heater 183). In this case, a magnetic flux concentrator or the like may be further included outside in the induction coil (not shown) in order to increase the efficiency of induction heating. The induction heater may include a susceptor, and may generate heat based on a magnetic field generated from the induction coil (not shown).

According to an embodiment, the heater 183 may be a multi-heater. The multi-heater may include a first heater and a second heater, and may be inserted into the cigarette 2. The first heater and the second heater may be arranged side by side along a longitudinal direction. The first heater and the second heater may operate as electro-resistive heaters and/or induction heaters, and may be heated sequentially or simultaneously. In this case, the first heater and the second heater may be respectively located at positions corresponding to positions of two or more aerosol generating rods in the longitudinal direction. Alternatively, the first heater and the second heater may be respectively located at positions corresponding to positions of a first part and a second part of one aerosol generating rod in the longitudinal direction. When the heater 183 is an induction heater, the aerosol generating device 100 may include a first induction coil and a second induction coil, and the first induction coil and the second induction coil may be respectively located at positions corresponding to the first heater and the second heater in the longitudinal direction. Alternatively, the first heater and the second heater may be respectively located at positions corresponding to positions of a first part and a second part of one heater 183 in the longitudinal direction. Also, three or more heaters and/or induction coils may be included.

Unlike what is shown, the aerosol generating device 100 may not include the heater 183. The cigarette 2 may be directly or indirectly heated by the cartridge heater 240, or may not be substantially heated. When indirectly heated, it may mean that when an aerosol generated by the cartridge heater 240 passes through the cigarette 2, the cigarette 2 is heated by receiving heat accommodated in the aerosol. In this case, the aerosol generating device 100 may be referred to as a non-heating type (or indirect heating type) aerosol generating device. An additive such as a basic material may be included in an aerosol generating rod of the cigarette 2. Based on this basic material, nicotine included in the aerosol generating rod may have a basic pH (e.g., pH 7.0 or higher). The basic nicotine may flow into the user's oral cavity together with an aerosol introduced from the cartridge 19 into the cigarette 2 described below.

Unlike what is shown, the heater 183 may include an internal heating-type heater. For example, the internal heating-type heater may include any of various heating element such as a rod-shaped heating element, a tubular heating element, a plate-shaped heating element, or a needle-shaped heating element. The internal heating-type heater may be inserted through a lower portion of the cigarette 2 and may be set to heat the inside of the cigarette 2.

According to an embodiment, the cartridge 19 may be detachably coupled to the housing 10. For example, a space may be formed on one side of the housing 10, and at least a part of the cartridge 19 may be inserted into the space formed on one side of the housing 10 so that the cartridge 19 is mounted on the housing 10. Alternatively, the cartridge 19 may be integrally formed with the housing 10.

According to an embodiment, an airflow channel through which air flows may be provided in the aerosol generating device 100 and/or the cartridge 19. For example, the housing 10 may have a structure in which external air may be introduced into the housing 10 in a state where the cartridge 19 is inserted. The introduced air may pass through the cartridge 19 and may be introduced into the insertion space through the airflow channel CN, and may flow into the user's oral cavity. Various structures for reducing remaining droplets or facilitating air flow may be included in the airflow channel CN.

Although the cartridge 19 is located laterally relative to the cigarette 2 and the airflow channel CN is formed from a side surface of the cigarette 2 to a lower end (i.e., an upstream side) of the cigarette 2, positions of the cartridge 19 and the airflow channel CN are not limited thereto. For example, the cartridge 19 may be located adjacent to the lower end (i.e., the upstream side) of the cigarette 2, and in this case, the airflow channel CN may be formed in a substantially linear shape to connect the cartridge 19 to the lower end (i.e., the upstream side) of the cigarette 2.

According to an embodiment, the cartridge 19 may include the chamber C0 in which an aerosol generating material is contained, the cartridge heater 240, and/or a liquid delivery means in which an aerosol generating material is impregnated (contained). The liquid delivery means 25 may impregnate the aerosol generating material supplied from the chamber C0. For example, the liquid delivery means may include a wick such as cotton fiber, ceramic fiber, glass fiber, or porous ceramic.

According to an embodiment, the cartridge heater 240 may heat an aerosol generating material included in the cartridge 19. For example, the cartridge heater 240 may include an electro-resistive heater and/or an induction heater.

For example, the electro-resistive heater may include an electro-resistive material, and may be heated as current flows through the electro-resistive material. In another example, when the cartridge heater 240 is an induction heater, the aerosol generating device 100 may further include an induction coil (not shown) around the induction heater. The induction heater may include a susceptor, and may generate heat based on a magnetic field generated from the induction coil (not shown). The cartridge heater 240 may be formed in a coil shape that is wound around a liquid delivery means and/or in a shape (e.g., a pattern shape) that contacts one side of the liquid delivery means.

Unlike what is shown, the cartridge heater 240 may be included in the aerosol generating device 100. For example, the cartridge heater 240 may be included in the housing 10. In this case, the cartridge 19 and the cartridge heater 240 may be separated by removing the cartridge 19.

According to an embodiment, an aerosol may be generated based on heat generation of the cartridge heater 240. For example, as an aerosol generating material impregnated in the liquid delivery means is heated by the cartridge heater 240, vapor may be generated from the aerosol generating material, and as the generated vapor is mixed with external air introduced into the cartridge 19, an aerosol may be generated. The aerosol generated by the cartridge heater 240 may be introduced into the cigarette 2 through the airflow channel CN. While the aerosol passes through the cigarette 2, a tobacco or flavoring material may be added to the aerosol, and the aerosol to which the tobacco or flavoring material is added may be inhaled into the user's oral cavity through one end of the cigarette 2.

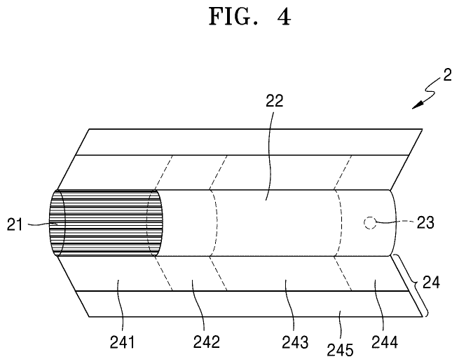

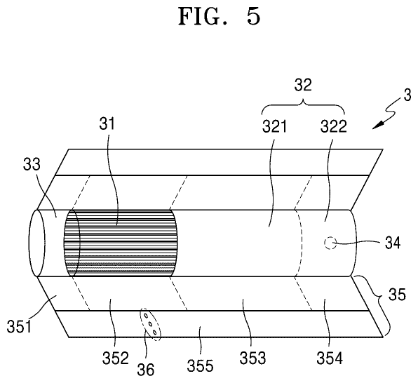

Hereinafter, an example of the cigarette 2 will be described with reference to FIGS. 4 and 5.

FIGS. 4 and 5 illustrate examples of the cigarette.

Referring to FIG. 4, the cigarette 2 may include a tobacco rod 21 and a filter rod 22.

FIG. 4 illustrates that the filter rod 22 includes a single segment. However, the filter rod 22 is not limited thereto. In other words, the filter rod 22 may include a plurality of segments. For example, the filter rod 22 may include a segment configured to cool an aerosol and a segment configured to filter a certain component included in the aerosol. Also, as necessary, the filter rod 22 may further include at least one segment configured to perform other functions.

The diameter of the cigarette 2 may be within the range of about 5 mm to about 9 mm and the length of the cigarette 2 may be about 48 mm. However, the disclosure is not limited thereto. For example, the length of the tobacco rod 21 may be about 12 mm, the length of the first segment of the filter rod 22 may be about 10 mm, the length of the second segment of the filter rod 22 may be about 14 mm, and the length of the third segment of the filter rod 22 may be about 12 mm. However, disclosure is not limited thereto.

The cigarette 2 may be packaged using at least one wrapper 24. The wrapper 24 may have at least one hole through which external air may be introduced or internal air may be discharged. For example, the cigarette 2 may be packaged by one wrapper 24. As another example, the cigarette 2 may be doubly packaged by two or more wrappers 24. For example, the tobacco rod 21 may be packaged by a first wrapper 241, and the filter rod 22 may be packaged by wrappers 242, 243, 243. And the entire cigarette 2 may be packaged by a single wrapper 245. When the filter rod 22 is composed of a plurality of segments, each segment may be packaged by separate wrappers 242, 243, 244.

The first wrapper 241 and the second wrapper 242 may each include general filter wrapping paper. For example, the first wrapper 241 and the second wrapper 242 may each include porous wrapping paper or non-porous wrapping paper. In addition, the first wrapper 241 and the second wrapper 242 may each include paper having oil resistance and/or an aluminum laminate packaging material.

The third wrapper 243 may include hard wrapping paper. For example, the basis weight of the third wrapper 243 may be in the range of about 88 g/m² to about 96 g/m², specifically, in the range of about 90 g/m² to about 94 g/m². In addition, the thickness of the third wrapper 243 may be in the range of about 120 um to about 130 um, specifically, 125 um.

The fourth wrapper 244 may include oil-resistant hard wrapping paper. For example, the basis weight of the fourth wrapper 244 may be in the range of about 88 g/m² to about 96 g/m², specifically, in the range of about 90 g/m² to about 94 g/m². In addition, the thickness of the fourth wrapper 244 may be in the range of about 120 um to about 130 um, specifically 125 um.

The fifth wrapper 245 may include sterile paper (MFW). Here, the MFW refers to paper specially prepared so that tensile strength, water resistance, smoothness, etc. thereof are further improved compared to those of general paper. For example, the basis weight of the fifth wrapper 245 may be in the range of about 57 g/m² to about 63 g/m², specifically, 60 g/m². In addition, the thickness of the fifth wrapper 245 may be in the range of about 64 um to about 70 um, specifically, 67 um.

A certain material may be internally added to the fifth wrapper 245. Here, an example of the certain material may include silicon, but is not limited thereto. For example, silicon has characteristics, such as heat resistance with little change with temperature, resistance to oxidation, resistance to various chemicals, water repellency against water, or electrical insulation. However, even though the certain material is not silicon, any material having the characteristics described above may be applied to (or coated on) the fifth wrapper 245 without limitation.

The fifth wrapper 245 may prevent the cigarette 2 from burning. For example, when the tobacco rod 21 is heated by the heater 13, there is a possibility that the cigarette 2 is burned. Specifically, when the temperature rises above the ignition point of any one of the materials included in the tobacco rod 21, the cigarette 2 may be burned. Even in this case, because the fifth wrapper 245 includes a non-combustible material, a burning phenomenon of the cigarette 2 may be prevented.

In addition, the fifth wrapper 245 may prevent the aerosol generating device 100 from being contaminated by substances generated in the cigarette 2. By a user's puff, liquid substances may be generated in the cigarette 2. For example, as an aerosol generated in the cigarette 2 is cooled by the outside air, liquid substances (e.g., moisture, etc.) may be generated. As the fifth wrapper 245 wraps the cigarette 2, the liquid substances generated in the cigarette 2 may be prevented from leaking out of the cigarette 2.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat conductive material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may include a cellulose acetate filter. For example, the first segment may include a tube-shaped structure including a hollow therein. When the heater 13 is inserted by the first segment, the inner material of the tobacco rod 21 may be prevented from being pushed back, and a cooling effect of the aerosol may occur. The diameter of the hollow included in the first segment may be an appropriate diameter within the range of about 2 mm to about 4.5 mm, but is not limited thereto.

The length of the first segment may be an appropriate length within the range of about 4 mm to about 30 mm, but is not limited thereto. Specifically, the length of the first segment may be 10 mm, but is not limited thereto.

The hardness of the first segment may be adjusted by adjusting the content of a plasticizer in the manufacture of the first segment. In addition, the first segment may be manufactured by inserting a structure, such as a film or a tube including the same material or different materials, inside the first segment (e.g., into the hollow).

The second segment of the filter rod 22 cools the aerosol generated as the heater 13 heats the tobacco rod 21. Thus, a user may inhale the aerosol cooled to a suitable temperature.

The length or diameter of the second segment may be variously determined according to the shape of the cigarette 2. For example, the length of the second segment may be appropriately determined within the range of about 7 mm to about 20 mm. Specifically, the length of the second segment may be about 14 mm, but is not limited thereto.

The second segment may be fabricated by weaving polymer fibers. In this case, a flavored liquid may be applied to fibers made of polymer. Alternatively, the second segment may be fabricated by weaving a fiber to which a flavored liquid is applied and a fiber made of a polymer together. Alternatively, the second segment may be formed by a crimped polymer sheet.

For example, the polymer may include a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by a woven polymer fiber or crimped polymer sheet, the second segment may include a single channel or a plurality of channels extending in a longitudinal direction thereof. Here, the channel refers to a passage through which a gas (e.g., air or aerosol) passes.

For example, the second segment formed by the crimped polymer sheet may be formed from a material having a thickness between about 5 μm and about 300 μm, such as between about 10 μm and about 250 μm. Also, the total surface area of the second segment may be between about 300 mm²/mm and about 1000 mm²/mm. Furthermore, an aerosol cooling element may be formed from a material having a specific surface area between about 10 mm²/mg and about 100 mm²/mg.

The second segment may include a thread containing a volatile flavor ingredient. Here, the volatile flavor ingredient may be menthol, but is not limited thereto. For example, the thread may be filled with a sufficient amount of menthol to provide 1.5 mg or more of menthol to the second segment.

The third segment of the filter rod 22 may include a cellulose acetate filter. The length of the third segment may be appropriately determined within the range of about 4 mm to about 20 mm. For example, the length of the third segment may be about 12 mm, but is not limited thereto.

The third segment may be fabricated such that flavor is generated by spraying a flavored liquid on the third segment in the process of fabricating the third segment. Alternatively, a separate fiber to which a flavored liquid is applied may be inserted into the third segment. The aerosol generated by the tobacco rod 21 is cooled as the aerosol passes through the second segment of the filter rod 22, and the cooled aerosol is delivered to a user through the third segment. Accordingly, when a flavoring element is added to the third segment, an effect of enhancing the durability of a flavor delivered to the user may occur.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 5, the cigarette 3 according to an embodiment may further include a front-end plug 33. The front-end plug 33 may be located on one side of the tobacco rod 31 which is opposite to the filter rod 32. The front-end plug 33 may prevent the tobacco rod 31 from being detached outwards and prevent the liquefied aerosol from flowing from the tobacco rod 31 into the aerosol generating device (1 of FIGS. 1 through 3), during smoking.

The filter rod 32 may include a first segment 321 and second segment 322. Here, the first segment 321 can correspond to a first segment of a filter rod 22 of FIG. 4, and the second segment 322 can correspond to a third segment of a filter rod 22 of FIG. 4.

The diameter and total length of the cigarette 3 can correspond to the diameter and total length of the cigarette 2 of FIG. 4. For example, the length of the front-end plug 33 may be about 7 mm, the length of the tobacco rod 31 may be about 15 mm, the length of the first segment 321 may be about 12 mm, and the length of the second segment 322 may be about 14 mm, but it is not limited to this.

The cigarette 3 may be packaged via at least one wrapper 35. The wrapper 35 may have at least one hole through which external air may be introduced or internal air may be discharged. For example, the front-end plug 33 may be packaged via a first wrapper 351, and the tobacco rod 31 may be packaged via a second wrapper 352, and the first segment 321 may be packaged via a third wrapper 353, and the second segment 322 may be packaged via a fourth wrapper 354. Also, the entire cigarette 3 may be packaged via a fifth wrapper 355.

Also, the fifth wrapper 355 may have at least one hole 36. For example, the hole 36 may be formed in an area surrounding the tobacco rod 31, but is not limited thereto. The hole 36 may serve to transfer heat formed by the heater 13 shown in FIG. 2 and FIG. 3 to the inside of the tobacco rod 31.

Also, the second segment 322 may include at least one capsule 34. Here, the capsule 34 may generate a flavor or an aerosol. For example, the capsule 34 may have a configuration in which a liquid containing a flavoring material is wrapped with a film. For example, the capsule 34 may have a spherical or cylindrical shape, but is not limited thereto.

The first wrapper 351 may include general filter wrapping paper to which a metal foil, such as an aluminum foil, is coupled. For example, the total thickness of the first wrapper 351 may be in the range of about 45 um to about 55 um, specifically 50.3 um. In addition, the thickness of the metal foil of the first wrapper 351 may be in the range of about 6 um to about 7 um, specifically 6.3 um. In addition, the basis weight of the first wrapper 351 may be in the range of about 50 g/m² to about 55 g/m², specifically 53 g/m^{2.}

The second wrapper 352 and the third wrapper 353 may each include general filter wrapping paper. For example, the second wrapper 352 and the third wrapper 353 may each include porous wrapping paper or non-porous wrapping paper.

For example, the porosity of the second wrapper 352 may be 35,000 CU, but is not limited thereto. In addition, the thickness of the second wrapper 352 may be in the range of about 70 um to about 80 um, specifically 78 um. In addition, the basis weight of the second wrapper 352 may be in the range of about 20 g/m² to about 25 g/m², specifically, 23.5 g/m^{2.}

For example, the porosity of the third wrapper 353 may be 24,000 CU, but is not limited thereto. In addition, the thickness of the third wrapper 353 may be in the range of about 60 um to about 70 um, specifically 68 um. In addition, the basis weight of the third wrapper 353 may be in the range of about 20 g/m² to about 25 g/m², specifically 21 g/m^{2.}

The fourth wrapper 354 may include PLA laminated paper. Here, the PLA laminated paper refers to a three-ply paper including a paper layer, a PLA layer, and a paper layer. For example, the thickness of the fourth wrapper 354 may be in the range of about 100 um to about 120 um, specifically 110 um. In addition, the basis weight of the fourth wrapper 354 may be in the range of about 80 g/m² to about 100 g/m², specifically 88 g/m².

The fifth wrapper 355 may include MFW. Here, the MFW refers to paper specially prepared so that tensile strength, water resistance, smoothness, etc. thereof are further improved compared to those of general paper. For example, the basis weight of the fifth wrapper 355 may be in the range of about 57 g/m² to about 63 g/m², specifically 60 g/m². In addition, the thickness of the fifth wrapper 355 may be in the range of about 64 um to about 70 um, specifically 67 um.

A certain material may be internally added to the fifth wrapper 355. Here, an example of the certain material may include silicon, but is not limited thereto. For example, silicon has characteristics, such as heat resistance with little change with temperature, resistance to oxidation, resistance to various chemicals, water repellency against water, or electrical insulation. However, even though the certain material is not silicon, any material having the characteristics described above may be applied to (or coated on) the fifth wrapper 355 without limitation.

The front-end plug 33 may include cellulose acetate. As an example, the front-end filter 33 may be fabricated by adding a plasticizer (e.g., triacetin) to a cellulose acetate tow. The mono denier of a filament constituting the cellulose acetate tow may be in the range of about 1.0 to about 10.0, specifically in the range of about 4.0 to about 6.0. More specifically, the mono denier of the filament of the front-end filter 33 may be 5.0. In addition, the cross-section of the filament constituting the front-end filter 33 may have a Y-shape. The total denier of the front-end filter 33 may be in the range of about 20,000 to about 30,000, specifically in the range of about 25,000 to about 30,000. More specifically, the total denier of the front-end filter 33 may be 28,000.

In addition, if necessary, the front-end filter 33 may include at least one channel, and the cross-section of the channel may have various shapes.

The tobacco rod 31 may correspond to the tobacco rod 21 described above with reference to FIG. 4. Therefore, a detailed description of the tobacco rod 31 is omitted below.

The first segment 321 may include cellulose acetate. For example, the first segment may include a tube-shaped structure including a hollow therein. The first segment 321 may be fabricated by adding a plasticizer (e.g., triacetin) to the cellulose acetate tow. For example, the mono denier and total denier of the first segment 321 may be the same as the mono denier and total denier of the front-end filter 33.

The second segment 322 may include cellulose acetate. The mono denier of a filament constituting the second segment 322 may be in the range of about 1.0 to about 10.0, specifically in the range of about 8.0 to about 10.0. More specifically, the mono denier of the filament of the second segment 322 may be 9.0. In addition, the cross-section of the filament of the second segment 322 may have a Y-shape. The total denier of the second segment 322 may be in the range of about 20,000 to about 30,000, specifically 25,000.

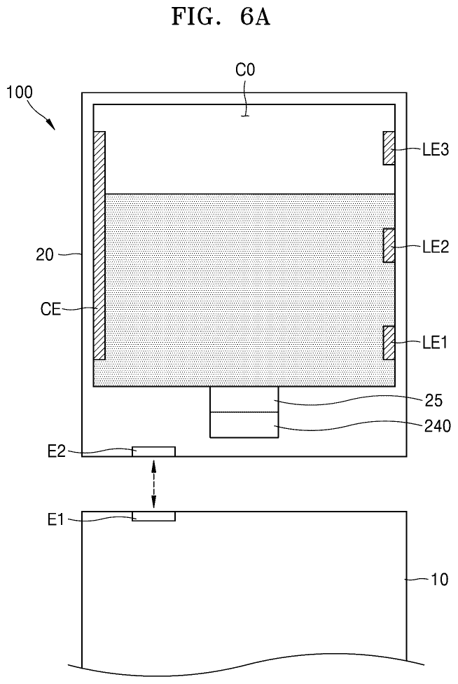

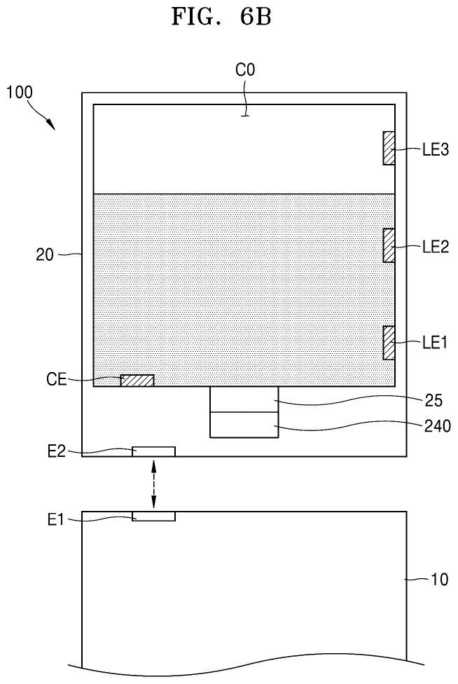

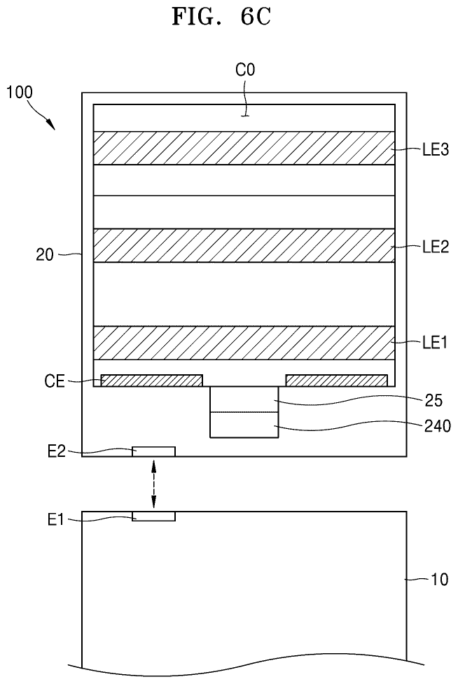

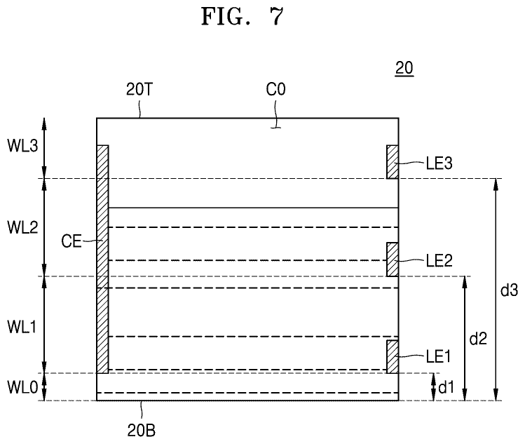

FIGS. 6A to 6C are schematic views for describing a cartridge, according to an embodiment. FIG. 7 is a view for describing a positional relationship between a common electrode and a plurality of level electrodes and a method of detecting a liquid level, according to an embodiment. In this case, the cartridge 20 of FIGS. 6A to 6C may correspond to the cartridge 20 of FIGS. 2 and 3. Hereinafter, the same description as that made above will be omitted, and a common electrode CE and level electrodes (e.g., LE1, LE2, and LE3) will be mainly described.

Referring to FIGS. 1 to 3 and FIGS. 6A to 6C, the aerosol generating device 100 according to an embodiment may include the housing 10 and the cartridge 20.

The cartridge 20 may include the chamber C0, the common electrode CE, the level electrodes (e.g., LE1, LE2, and LE3), the liquid delivery means 25, and the cartridge heater 240. In this case, the common electrode CE and the level electrodes (e.g., LE1, LE2, and LE3) are elements of a sensor unit (not shown) for measuring a water level of a liquid in the chamber C0.

The chamber C0 may store a liquid aerosol generating material therein. The chamber C0 may be detachably coupled to the housing 10 of the aerosol generating device 100 or may be integrally formed in the housing 10 of the aerosol generating device 100.

The liquid aerosol generating material in the chamber C0 may be heated by the cartridge heater 240. The liquid delivery means 25 may be connected to the chamber C0. The liquid delivery means 25 may receive a liquid from the chamber C0. The liquid aerosol generating material may be impregnated in the liquid delivery means 25. The cartridge heater 240 may be electrically connected to the power source 110 and/or the controller 120. The cartridge heater 240 may heat a liquid aerosol generating material in the liquid delivery means 25.

The chamber C0 may include one common electrode CE and a plurality of level electrodes (e.g., LE1, LE2, and LE3) on a side surface therein. The common electrode CE and the level electrodes (e.g., LE1, LE2, and LE3) according to an embodiment may be formed of titanium to enhance corrosion resistance.

Referring to FIGS. 6A and 7, when the common electrode CE is disposed on one side surface of the chamber C0, the plurality of level electrodes (e.g., LE1, LE2, and LE3) may be disposed on the other side surface of the chamber C0 so that the common electrode CE and the plurality of level electrodes (e.g., LE1, LE2, and LE3) face each other.

The common electrode CE is a rod-shaped electrode extending from a bottom surface 20B of the chamber C0 toward a top surface 20T of the chamber C0, and may be disposed on one side surface in the chamber C0.

However, this is only an example, and a cross-sectional shape, a size, and a length of the common electrode CE may be modified in various ways. For example, as shown in FIG. 6B, the common electrode CE is an electrode having the same shape and size as each of the level electrodes (e.g., LE1, LE2, and LE3), and may be disposed on a portion on the bottom surface 20B of the chamber C0.

Also, as shown in FIG. 6C, the common electrode CE may be disposed on the entire bottom surface 20B of the chamber C0 except for a portion overlapping the liquid delivery means 25.

Referring to FIGS. 6A, 6B, and 7, the level electrodes (e.g., LE1, LE2, and LE3) are electrodes spaced apart from each other, and may be arranged on the other side surface in the chamber C0 along a longitudinal direction of the chamber C0 to be spaced apart from each other by a certain interval. For example, the level electrodes (e.g., LE1, LE2, and LE3) may include a first level electrode LE1, a second level electrode LE2, and a third level electrode LE3 which are sequentially disposed from the bottom surface 20B of the chamber C0 toward the top surface 20T of the chamber C0. In this case, a shortest distance between a lower end of the common electrode CE and the bottom surface 20B of the chamber C0 may be substantially the same as a shortest distance between a lower end of the first level electrode LE1 and the bottom surface 20B of the chamber C0.

A planar shape of each of the first, second, and third level electrodes LE1, LE2, and LE3 may be a rectangular shape having a short side in the longitudinal direction of the chamber C0 and a long side in a direction perpendicular to the longitudinal direction of the chamber C0. However, this is only an example, and a cross-sectional shape, a size, and a length of each of the first, second, and third level electrodes LE1, LE2, and LE3 may be modified in various ways. For example, a cross-sectional shape of each of the first, second, and third level electrodes LE1, LE2, and LE3 may be a circular shape.

Referring to FIG. 6C, in another example, when the common electrode CE is disposed on at least a portion of the bottom surface 20B of the chamber C0, the first, second, and third level electrodes LE1, LE2, and LE3 may be arranged in a ring shape (not shown) on a side surface in the chamber C0 along the direction perpendicular to the longitudinal direction of the chamber C0.

Referring back to FIGS. 6A and 7, the cartridge 20 may include a second connection terminal E2 on one side of a surface coupled to the housing 10. The second connection terminal E2 may be electrically connected to the common electrode CE and the first, second, and third level electrodes LE1, LE2, and LE3. In this case, the common electrode CE and the first, second, and third level electrodes LE1, LE2, and LE3 are insulated from each other. When the cartridge 20 is coupled to the housing 10, the second connection terminal E2 may be electrically connected to a first connection terminal E1 of the housing 10. The first connection terminal E1 may be provided on one side of a surface where the housing 10 is coupled to the cartridge 20. The sensor unit (or the common electrode CE and the first, second, and third level electrodes LE1, LE2, and LE3) may be electrically connected to the controller 120 through the first connection terminal E1 and the second connection terminal E2.

The controller 120 may activate the sensor unit (or the common electrode CE and the first, second, and third level electrodes LE1, LE2, and LE3) and may receive a signal output from the sensor unit (or the common electrode CE and the first, second, and third level electrodes LE1, LE2, and LE3). The signal output from the sensor unit (or the common electrode CE and the first, second, and third level electrodes LE1, LE2, and LE3) may be an analog signal or a digital signal. The controller 120 may calculate whether there is electrical connection between the common electrode CE and at least one of the first, second, and third level electrodes LE1, LE2, and LE3, based on the signal received from the sensor unit (or the common electrode CE and the first, second, and third level electrodes LE1, LE2, and LE3).

The controller 120 may detect the amount of a liquid aerosol generating material in the chamber C0, based on whether there is electrical connection between the common electrode CE and at least one of the first, second, and third level electrodes LE1, LE2, and LE3. The controller 120 may control power supplied to the cartridge heater 240, based on the amount of the liquid aerosol generating material. For example, the aerosol generating device 100 may supply power to the cartridge heater 240, based on a temperature profile stored in the memory 170.

The controller 120 may control power supplied to the cartridge heater 240, based on the detected amount of the aerosol generating material.

The controller 120 may compare the amount of the liquid aerosol generating material in the chamber C0 with a preset value, and may control power to be supplied to the cartridge heater 240, based on the amount of the liquid aerosol generating material in the chamber C0 being greater than or equal to the preset value. When the amount of the liquid aerosol generating material in the chamber C0 is less than the preset value, the controller 120 may determine that a sufficient amount of aerosol for the user to inhale may not be generated or the aerosol generating material is exhausted.

The controller 120 may control power supply to the cartridge heater 240 to be cut off, based on the amount of the liquid aerosol generating material in the chamber C0 being less than the preset value. Also, when there is no electrical connection between the common electrode CE and the first level electrode LE1, the controller 120 may output a replacement alarm of the cartridge 20 through the output unit 140.

The controller 120 may control information about the detected amount of the aerosol generating material to be output through the output unit 140. For example, the controller 120 may control the amount of the aerosol generating material to be expressed as a number through the output unit 140. For example, the controller 120 may control the amount of the aerosol generating material to a total capacity of the chamber C0 to be expressed as a percentage (%) value through the output unit 140. A method of outputting the amount of the aerosol generating material is not limited thereto.

The power source 110 may supply power to the cartridge heater 240, under the control of the controller 120.

Referring to FIG. 7, the sensor unit including the common electrode CE and the first, second, and third level electrodes LE1, LE2, and LE3 may detect to which water level range a water level of the liquid aerosol generating material in the chamber C0 belongs from among water level ranges WL0, WL1, WL2, and WL3. The detection may be performed by detecting whether there is electrical connection between the common electrode CE and each of the first, second, and third level electrodes LE1, LE2, and LE3. A state where there is electrical connection between two electrodes is referred to as a conductive state, and a state where there is no electrical connection between two electrodes is referred to as a non-conductive state.

For a target level electrode that is any one of the first, second, and third level electrodes LE1, LE2, and LE3, a conductive state between the common electrode CE and the target level electrode refers to a state where an electrical resistance value between the common electrode CE and the target level electrode is less than or equal to a reference resistance value, and a non-conductive state between the common electrode CE and the target level electrode refers to a state where an electrical resistance value between the common electrode CE and the target level electrode is greater than the reference resistance value. Electrical connection between the common electrode CE and the target level electrode is realized by electrically connecting the common electrode CE to the target level electrode through a liquid aerosol generating material in the chamber C0.

A water level of the liquid aerosol generating material in the chamber C0 refers to a height of a water surface of the liquid aerosol generating material in the chamber C0 as viewed from a bottom surface 10B. The water level range WL3 is a range in which a height of a water surface is greater than or equal to a distance d3. The water level range WL2 is a range in which a height of a water surface is greater than or equal to a distance d2 and less than the distance d3. The water level range WL1 is a range in which a height of a water surface is greater than or equal to a distance d1 andr less than the distance d2. The water level range WL0 is a range in which a height of a water surface is less than the distance d1.

When a water level of the liquid aerosol generating material in the chamber C0 belongs to the water level range WL3, because a part of the common electrode CE and a part of the third level electrode LE3 are immersed in the liquid aerosol generating material, the common electrode CE and the third level electrode LE3 become conductive through the liquid aerosol generating material. When a water level of the liquid aerosol generating material in the chamber C0 belongs to the water level range WL2, because the third level electrode LE3 does not contact the liquid aerosol generating material, the common electrode CE and the third level electrode LE3 become non-conductive, and because a part of the common electrode CE and a part of the second level electrode LE2 are immersed in the liquid aerosol generating material, the common electrode CE and the second level electrode LE2 become conductive through the liquid aerosol generating material. When a water level of the liquid aerosol generating material in the chamber C0 belongs to the water level range WL1, because the second level electrode LE2 and the third level electrode LE3 do not contact the liquid aerosol generating material, the common electrode CE and the second level electrode LE2 become non-conductive and the common electrode CE and the third level electrode LE3 become non-conductive, and because a part of the common electrode CE and a part of the first level electrode LE1 are immersed in the liquid aerosol generating material, the common electrode CE and the first level electrode LE1 become conductive through the liquid aerosol generating material. When a water level of the liquid aerosol generating material in the chamber C0 belongs to the water level range WL0, because the first level electrode LE1, the second level electrode LE2, and the third level electrode LE3 do not contact the liquid aerosol generating material, the common electrode CE and each of the first level electrode LE1, the second level electrode LE2, and the third level electrode LE3 become non-conductive.

Accordingly, the controller 120 may detect a water level of the liquid aerosol generating material in the chamber C0 in 4 steps by detecting whether there is electrical connection between the common electrode CE and each of the first, second, and third level electrodes LE1, LE2, and LE3. That is, when the common electrode CE and the third level electrode LE3 are in a conductive state, the controller 120 determines that a water level of the liquid aerosol generating material belongs to the water level range WL3. When the common electrode CE and the third level electrode LE3 are in a non-conductive state and the common electrode CE and the second level electrode LE2 are in a conductive state, the controller 120 determines that a water level of the liquid aerosol generating material belongs to the water level range WL2. When the common electrode CE and the second level electrode LE2 are in a non-conductive state and the common electrode CE and the first level electrode LE1 are in a conductive state, the controller 120 determines that a water level of the liquid aerosol generating material belongs to the water level range WL1. When the common electrode CE and the first level electrode LE1 are in a non-conductive state, the controller 120 determines that a water level of the liquid aerosol generating material belongs to the water level range WL0.

When an angle at which the aerosol generating device 100 is inclined is less than or equal to a certain angle, the aerosol generating device 100 may calculate the amount of the liquid aerosol generating material.

The aerosol generating device 100 (or the sensor unit 130) may include at least one sensor (hereinafter, referred to as a motion sensor) for detecting movement of the housing 10 and/or the cartridge 20 of the aerosol generating device 100. In this case, the motion sensor may be implemented by at least one of a gyro sensor and an acceleration sensor. The motion sensor may be disposed on at least one of the housing 10 and the cartridge 20.

The aerosol generating device 100 may calculate an angle of the chamber C0. The angle of the chamber C0 may be defined as an angle between a longitudinal direction of the chamber C0 and a vertical line perpendicular to the ground. The motion sensor may measure motion information including a movement state, a posture, a degree of inclination of the aerosol generating device 100, and may output a signal corresponding to the measured information. The aerosol generating device 100 may calculate an angle of the chamber C0 based on the signal received from the motion sensor.

The aerosol generating device 100 may compare the calculated angle of the chamber C0 with a preset threshold value. The aerosol generating device 100 may determine whether the calculated angle is less than the preset threshold value. For example, the preset threshold value may be 15°or 30°. However, the preset threshold value is not limited thereto.

The aerosol generating device 100 may output a warning through the output unit 140 based on the calculated angle being greater than or equal to the preset threshold value. For example, the aerosol generating device 100 may output, through the output unit 140, information indicating that the amount of the liquid aerosol generating material in the chamber C0 may not be measured because the chamber C0 is inclined. For example, the aerosol generating device 100 may output, through the output unit 140, information that guides the device to be aligned in a direction perpendicular to the ground because the chamber C0 is inclined.

After outputting the warning, the aerosol generating device 100 may receive a measurement signal from the motion sensor again.

The aerosol generating device 100 may activate the sensor unit (or the common electrode CE and the first, second, and third level electrodes LE1, LE2, and LE3) based on the calculated angle being less than the preset threshold value. The aerosol generating device 100 may activate the sensor unit by transmitting an activation signal to the sensor unit.

The aerosol generating device 100 may calculate the amount of the liquid aerosol generating material in the chamber C0 based on a signal received from the activated sensor unit.

Hereinafter, other embodiments will be described. In the following embodiments, the same configuration as that described in the above embodiments will not be described or will be briefly described, and a difference will be mainly described.

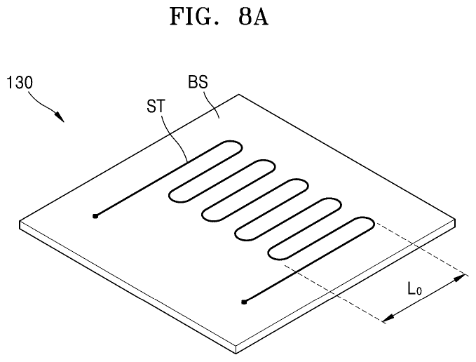

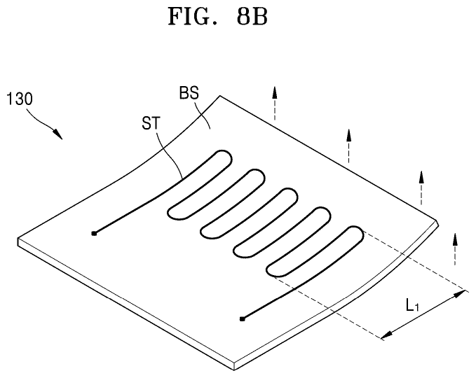

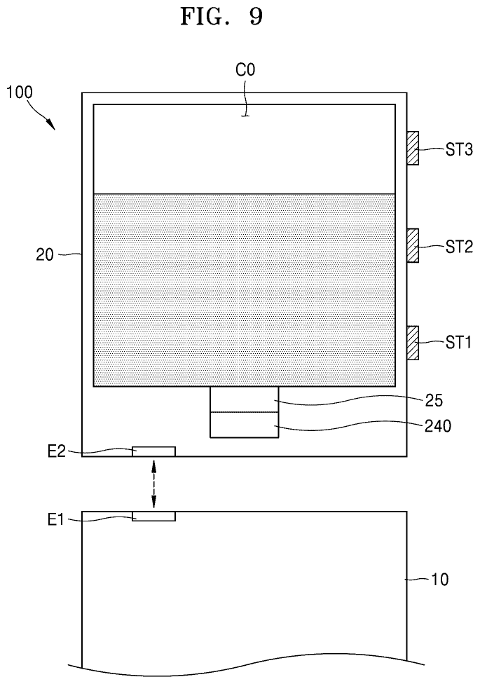

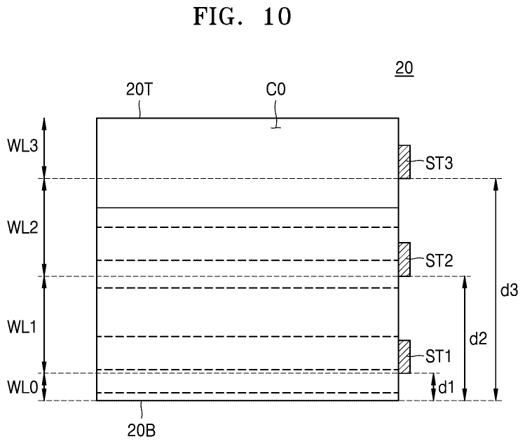

FIG. 8A is a view illustrating an aspect of a sensor unit including a strain gauge, according to an embodiment. FIG. 8B is a view illustrating another aspect of a sensor unit including a strain gauge, according to an embodiment. FIG. 9 is a schematic view for describing a cartridge, according to an embodiment. FIG. 10 is a view for describing a positional relationship between a plurality of strain gauges and a method of detecting a liquid level, according to an embodiment. In this case, the cartridge 20 of FIG. 7 may correspond to the cartridge 20 of FIGS. 2 and 3. Hereinafter, the same description as that made above will be omitted, and strain gauges (e.g., ST1, ST2, and ST3) will be mainly described.

Referring to FIGS. 1, 8A, and 8B, a strain gauge ST of the sensor unit 130 may be implemented as, for example, a Wheatstone bridge circuit. Because the Wheatstone bridge circuit may measure a change in resistance (i.e., a change in piezoresistance) corresponding to bending deformation relatively precisely and accurately, the Wheatstone bridge circuit may be a desirable sensing means for easily detecting a remaining amount of a liquid aerosol generating material in the cartridge 20.

The sensor unit 130 may include the strain gauge ST and a base BS on which the strain gauge ST is disposed. The base BS may be deformed by an external force (e.g., deformation of the chamber C0), and resistance of the strain gauge ST may change in response to the deformation of the base BS. Although not shown, the sensor unit 130 may be connected to the controller 120 (see FIG. 1) to transmit and receive an electrical signal or may be connected to the power source 110 (see FIG. 1) to receive power.

When the ‘strain gauge is disposed on the base’, it may mean that the strain gauge ST is disposed on the base BS so that resistance changes in response to deformation of the base BS. For example, the strain gauge ST may be mounted on a surface of the base BS or embedded in the base BS.

The base BS may be formed of a material having low rigidity that may be deformed by an external force, or may be manufactured in a shape having low rigidity. For example, the base BS may be manufactured to have a small thickness or cross-sectional area.

The strain gauge ST may include a metal material through which current may flow. For example, the metal material may include, but is not limited to, copper, aluminum, nickel, silver, gold, platinum, palladium, or an alloy thereof.

The strain gauge ST may include a material such as carbon powder, carbon nanotubes, or graphene.

The strain gauge ST may be disposed on the base BS by using a coating method including plating, deposition, or spraying, or a printing method.

The strain gauge may include a thin resistance wire arranged in a meandering pattern, and a change in the length of the strain gauge may be a multiple (e.g., 10 times) compared to a change in the length of a simple resistance wire. Accordingly, a relatively large resistance change may occur even with a small deformation in the strain gauge ST.

Referring to FIG. 8A, a length of a portion of the strain gauge ST in the sensor unit 130 (or the base BS) that is not deformed may be an initial length L₀, and referring to FIG. 8B, a length of a portion of the strain gauge ST in the sensor unit 130 that is deformed by an external force of a first intensity may be a first length L₁.

In this case, the first length L₁ may be greater than the initial length L₀. That is, when there is an external force applied to the base BS, the sensor unit 130 may be deformed, and thus, the strain gauge ST included in the sensor unit 130 may also be deformed to detect a change in resistance of the sensor unit 130. In other words, because a magnitude of a resistance value is proportional to a length of a resistor (e.g., the strain gauge ST) and is inversely proportional to a cross-sectional area, resistance of the strain gauge ST in the sensor unit 130 deformed by the external force of the first intensity may be greater than resistance of the strain gauge ST in the sensor unit 130 (or the base BS) that is not deformed.

Referring to FIGS. 1 to 3, and 7, the aerosol generating device 100 according to an embodiment may include the housing 10 and the cartridge 20.

The cartridge 20 may include the strain gauges (e.g., ST1, ST2, and ST3), the liquid delivery means 25, and the cartridge heater 240. In this case, in the strain gauges (e.g., ST1, ST2, and ST3) of FIG. 9, the base BS is not shown for convenience of explanation.

The chamber C0 may store a liquid aerosol generating material therein. The chamber C0 may be detachably coupled to the housing 10 of the aerosol generating device 100, or may be integrally formed in the housing 10 of the aerosol generating device 100.

The liquid aerosol generating material in the chamber C0 may be heated by the cartridge heater 240. The liquid delivery means 25 may be connected to the chamber C0. The liquid delivery means 25 may receive a liquid from the chamber C0. The liquid aerosol generating material may be impregnated in the liquid delivery means 25. The cartridge heater 240 may be electrically connected to the power source 110 and/or the controller 120. The cartridge heater 240 may heat a liquid aerosol generating material in the liquid delivery means 25.

Referring to FIGS. 9 and 10, the chamber C0 may include a plurality of strain gauges (e.g., ST1, ST2, and ST3). The plurality of strain gauges (e.g., ST1, ST2, and ST3) may be disposed on a side surface of an outer wall of the chamber C0.

The strain gauges (e.g., ST1, ST2, and ST3) may be arranged on one side surface of the outer wall of the chamber C0 along a longitudinal direction of the chamber C0 to be spaced apart from each other by a certain interval. For example, the strain gauges (e.g., ST1, ST2, and ST3) may include a first strain gauge ST1, a second strain gauge ST2, and a third strain gauge ST3 which are sequentially disposed from the bottom surface 20B of the chamber c0 toward the top surface 20T of the chamber C0. In this case, an outer wall of the chamber C0 (or the cartridge 20) includes one or more flexible members for providing flexibility so that the liquid aerosol generating material applies pressure to each of the first, second, and third strain gauges ST1, ST2, and ST3, and the pressure may be at least partially a function of a fluid volume of the liquid aerosol generating material.

Referring back to FIGS. 9 and 10, the cartridge 20 may include the second connection terminal E2 on one side of a surface coupled to the housing 10. The second connection terminal E2 may be electrically connected to each of the first, second, and third strain gauges ST1, ST2, and ST3. When the cartridge 20 is coupled to the housing 10, the second connection terminal E2 may be electrically connected to the first connection terminal E1 of the housing 10. The first connection terminal E1 may be provided on one surface of a surface where the housing 10 is coupled to the cartridge 20. The sensor unit (or the first, second, and third strain gauges ST1, ST2, and ST3) may be electrically connected to the controller 120 through the first connection terminal E1 and the second connection terminal E2.

The controller 120 may activate the sensor unit (or the first, second, and third strain gauges ST1, ST2, and ST3) and may receive a signal output from the sensor unit (or the first, second, and third strain gauges ST1, ST2, and ST3). The signal output from the sensor unit (or the first, second, and third strain gauges ST1, ST2, and ST3) may be an analog signal or a digital signal. The controller 120 may calculate a changed resistance value of at least one of the first, second, and third strain gauges ST1, ST2, and ST3, based on the signal received from the sensor unit (or the first, second, and third strain gauges ST1, ST2, and ST3).

The controller 120 may detect the amount of the liquid aerosol generating material in the chamber C0, based on the changed resistance value of at least one of the first, second, and third strain gauges ST1, ST2, and ST3. The controller 120 may control power supplied to the cartridge heater 240, based on the amount of the liquid aerosol generating material. For example, the aerosol generating device 100 may supply power to the cartridge heater 240, based on a temperature profile stored in the memory 170.

The controller 120 may control power supplied to the cartridge heater 240, based on the detected amount of the aerosol generating material.

The controller 120 may compare the amount of the liquid aerosol generating material in the chamber C0 with a preset value, and may control power to be supplied to the cartridge heater 240, based on the amount of the liquid aerosol generating material in the chamber C0 being greater than or equal to the preset value. When the amount of the liquid aerosol generating material in the chamber C0 is less than the preset value, the controller 120 may determine that a sufficient amount of aerosol for the user to inhale may be not generated or the aerosol generating material is exhausted.

The controller 120 may control power supply to the cartridge heater 240 to be cut off, based on the amount of the liquid aerosol generating material in the chamber C0 being less than the preset value. Also, when a change in a resistance value is detected from all of the first strain gauge ST1, the second strain gauge ST2, and the third strain gauge ST3, the controller 120 may output a replacement alarm of the cartridge 20 through the output unit 140.

The controller 120 may control information corresponding to the detected amount of the aerosol generating material to be output through the output unit 140. For example, the controller 120 may control the amount of the aerosol generating material to be expressed as a number through the output unit 140. For example, the controller 120 may control the amount of the aerosol generating material to a total capacity of the chamber C0 to be expressed as a percentage (%) value through the output unit 140. A method of outputting the amount of the aerosol generating material is not limited thereto.

The power source 110 may supply power to the cartridge heater 240, under the control of the controller 120.

Referring to FIG. 10, the sensor unit including the first, second, and third strain gauges ST1, ST2, and ST3 may detect to which water level range a water level of the liquid aerosol generating material in the chamber C0 belongs from among the water level ranges WOL0, WL1, WL2, and WL3. The detection may be performed by detecting whether there is a change in a resistance value (e.g., a decrease in a resistance value) in the first, second, and third strain gauges ST1, ST2, and ST3.

Regarding a target strain gauge that is any one of the first, second, and third strain gauges ST1, ST2, and ST3, a resistance value change state of the target strain gauge refers to a state less than a reference resistance value. The reference resistance value may be experimentally and statistically calculated, and for example, in a state where the liquid aerosol generating material is filled according to a water level, the reference resistance value may be determined by measuring a resistance value of a strain gauge. In this case, the reference resistance value may refer to a specific value or a specific range.

A water level of the liquid aerosol generating material in the chamber C0 refers to a height of a water level of the liquid aerosol generating material in the chamber C0 as viewed from the bottom surface 10B. The water level range WL3 is a range in which a height of a water surface is greater than or equal to the distance d3. The water level range WL2 is a range in which a height of a water surface is greater than or equal to the distance d2 and less than the distance d3. The water level range WL1 is a range in which a height of a water surface is greater than or equal to the distance d1 and less than the distance d2. The water level range WL0 is a range in which a height of a water surface is less than the distance d1.

When a water level of the liquid aerosol generating material in the chamber C0 belongs to the water level range WL3, it may be a case where there is no change in a resistance value in all of the first strain gauge ST1, the second strain gauge ST2, and the third strain gauge ST3. When a water level of the liquid aerosol generating material in the chamber C0 belongs to the water level range WL2, it may be case where there is a change in a resistance value only in the third strain gauge ST3, excluding the first strain gauge ST1 and the second strain gauge ST2. When a water level of the liquid aerosol generating material in the chamber C0 belongs to the water level range WL1, it may be a case where there is a change in a resistance value in the second strain gauge ST2 and the third strain gauge ST3, excluding the first strain gauge ST1. When a water level of the liquid aerosol generating material in the chamber C0 belongs to the water level range WL0, it may be case where there is a change in a resistance value in all of the first strain gauge ST1, the second strain gauge ST2, and the third strain gauge ST3.

Accordingly, the controller 120 may detect a water level of the liquid aerosol generating material in the chamber C0 in 4 steps by detecting whether there is a change in a resistance value in each of the first, second, and third strain gauges ST1, ST2, and ST3. That is, when there is no change in a resistance value in all of the first strain gauge ST1, the second strain gauge ST2, and the third strain gauge ST3, the controller 120 determines that a water level of the liquid aerosol generating material belongs to the water level range WL3. When there is a change in a resistance only in the third strain gauge ST3, the controller 120 determines that a water level of the liquid aerosol generating material belongs to the water level range WL2. When there is a change in a resistance value in the second strain gauge ST2 and the third strain gauge ST3, excluding the first strain gauge ST1, the controller 120 determines that a water level of the liquid aerosol generating material belongs to the water level range WL1. When there is a change in a resistance value in all of the first strain gauge ST1, the second strain gauge ST2, and the third strain gauge ST3, the controller 120 determines that a water level of the liquid aerosol generating material belongs to the water level range WL0.

When an angle at which the aerosol generating device 100 is inclined is less than or equal to a certain angle, the aerosol generating device 100 may calculate the amount of the liquid aerosol generating material.

The aerosol generating device 100 (or the sensor unit 130) may include at least one sensor (hereinafter, referred to as a motion sensor) for detecting movement of the housing 10 and/or the cartridge 20 of the aerosol generating device 100. In this case, the motion sensor may be implemented by at least one of a gyro sensor and an acceleration sensor. The motion sensor may be disposed on at least one of the housing 10 and the cartridge 20.

The aerosol generating device 100 may calculate an angle of the chamber C0. The angle of the chamber C0 may be defined as an angle between a longitudinal direction of the chamber C0 and a vertical line perpendicular to the ground. The motion sensor may measure motion information including a movement state, a posture, and a degree of inclination of the aerosol generating device 100, and may output a signal corresponding to the measured information. The aerosol generating device 100 may calculate an angle of the chamber C0 based on the signal received from the motion sensor.

The aerosol generating device 100 may compare the calculated angle of the chamber C0 with a preset threshold value. The aerosol generating device 100 may determine whether the calculated angle is less than the preset threshold value. For example, the preset threshold value may be 15°or 30°. However, the preset threshold value is not limited thereto.

The aerosol generating device 100 may output a warning through the output unit 140 based on the calculated angle being greater than or equal to the preset threshold value. For example, the aerosol generating device 100 may output, through the output unit 140, information indicating that the amount of the liquid aerosol generating material in the chamber C0 may not be measured because the chamber C0 is inclined. For example, the aerosol generating device 100 may output, through the output unit 140, information that guides the device to be aligned in a direction perpendicular to the ground because the chamber C0 is inclined.

After outputting the warning, the aerosol generating device 100 may receive a measurement signal from the motion sensor again.

The aerosol generating device 100 may activate the sensor unit (or the first, second, and third strain gauges ST1, ST2, and ST3) based on the calculated angle being less than the preset threshold value. The aerosol generating device may activate the sensor unit by transmitting an activation signal to the sensor unit.

The aerosol generating device 100 may calculate the amount of the liquid aerosol generating material in the chamber C0 based on a signal received from the activated sensor unit.

Any embodiments or other embodiments described above are not mutually exclusive or distinct from each other. Any embodiment or other embodiments described in this disclosure may be combined with each other, both in terms of configurations and functions.

For example, configuration A described in a specific embodiment and/or drawing may be combined with configuration B described in another embodiment and/or drawing. This means that even if a combination of configurations is not explicitly described, the combination is still possible unless specifically stated otherwise.

The above detailed description should not be construed as limiting in any way but rather considered as illustrative. The scope of the present invention should be determined by the reasonable interpretation of the appended claims, and all modifications within the equivalent scope of the invention are to be included within the scope of the invention.

An aerosol generating device according to an embodiment may measure a remaining amount of a liquid accommodated in a cartridge, by using a level sensor or a strain gauge.

Effects of the embodiments are not limited thereto, and other unmentioned effects will be apparent to one of ordinary skill in the art to which the embodiments pertain from the present specification and the attached drawings.

What is claimed is:

1. An aerosol generating device comprising:
a cartridge comprising a chamber in which a liquid aerosol generating material is stored;
a sensor unit disposed on a side surface in the chamber and comprising a common electrode and one or more level electrodes; and
a controller configured to calculate an amount of the liquid aerosol generating material in the chamber, based on whether there is electrical connection between the common electrode and the one or more level electrodes.

2. The aerosol generating device of claim 1, wherein
the common electrode is integrally formed on one side surface of the chamber along a longitudinal direction of the chamber, and
the one or more level electrodes are arranged on the other side surface of the chamber along the longitudinal direction of the chamber to be spaced apart from each other by a certain interval.

3. The aerosol generating device of claim 2, wherein the one or more level electrodes comprise a first level electrode, a second level electrode, and a third level electrode sequentially disposed from a bottom surface of the chamber toward a top surface of the chamber.

4. The aerosol generating device of claim 3, wherein a shortest distance between a lower end of the common electrode and the bottom surface of the chamber is substantially same as a shortest distance between a lower end of the first level electrode and the bottom surface of the chamber.

5. The aerosol generating device of claim 4, wherein the controller is further configured to output a replacement alarm of the cartridge through an output unit, when there is no electrical connection between the common electrode and the first level electrode.

6. The aerosol generating device of claim 1, further comprising:
a motion sensor; and
an output unit,
wherein the controller is further configured to
determine an angle between the chamber and a direction perpendicular to a ground, based on a signal received from the motion sensor,
output a warning through the output unit, based on the angle being greater than or equal to a preset threshold value, and
activate the sensor unit to calculate an amount of the liquid aerosol generating material in the chamber, based on the angle being less than the preset threshold value.

7. The aerosol generating device of claim 1, wherein the common electrode is an electrode having the same shape and size as each of the one or more level electrodes, and is disposed on a portion on a bottom surface of the chamber.

8. The aerosol generating device of claim 1, wherein the cartridge comprises an atomizing unit configured to vaporize the liquid aerosol generating material.

9. The aerosol generating device of claim 8,
wherein the atomizing unit includes a liquid delivery means for impregnating the aerosol generating material supplied from the chamber and a heater for heating the aerosol generating material, and
wherein the common electrode is disposed on an entire bottom surface of the chamber except for a portion overlapping the liquid delivery means.

10. The aerosol generating device of claim 1, further comprising a housing comprising an insertion space into which a cigarette is inserted, wherein the insertion space is in fluid communication with the cartridge.
